(19) United States
(12) Patent Application Publication
(10) Pub. No.: US 2026/0102656 A1
(43) Pub. Date: Apr. 16, 2026

(54) Systems and Methods for Determining the Orientation of Motion-Sensing Devices During Physical Activity

(71) Applicant: Motion Metrics Limited, London (GB)

(72) Inventors: James Anthony Salter, London (GB); Sam Jana van den Brink, Innsbruck (AT); Harry Charles Bickerton, Squamish (CA); Pruthvikar Reddy Mosali, Oxford (GB)

(21) Appl. No.: 19/355,123

(22) Filed: Oct. 10, 2025

Related U.S. Application Data
(60) Provisional application No. 63/706,165, filed on Oct. 11, 2024.

(51) Int. Cl. A63B 24/00; A63B 69/00; A63B 69/18; A63B 71/06; G01P 21/00

(52) U.S. Cl. CPC A63B 24/0006; A63B 24/0062; A63B 69/0093; A63B 69/18; G01P 21/00; A63B 2024/0012; A63B 2024/0068; A63B 71/0622; A63B 2071/0625; A63B 2071/0655; A63B 2220/16; A63B 2220/34; A63B 2220/40; A63B 2220/62; A63B 2220/803; A63B 2220/808; A63B 2220/833; A63B 2220/836

(57) ABSTRACT

A computer-implemented method for providing real-time performance feedback includes receiving uncalibrated time-series motion data generated by one or more motion sensors coupled directly or indirectly to an athlete while performing a downhill snow sport, the motion sensor(s) having an unknown rotational orientation relative to the athlete; determining an estimated rotational offset of the motion sensor(s) relative to a body-segment coordinate frame of the athlete, the rotational offset determined using a calibration model; transforming, by the one or more processors, the uncalibrated time-series motion data to calibrated time-series motion data according to the estimated rotational offset, the calibrated time-series motion data aligned with the body-segment coordinate frame; and processing the calibrated time-series data, with the one or more processors, to determine one or more metrics for the athlete.

### CROSS-REFERENCE TO RELATED APPLICATIONS

This application claims priority to U.S. Provisional Application No. 63/706,165, titled “Systems And Methods For Determining The Orientation Of Motion Sensing Devices During Physical Activity,” filed on Oct. 11, 2024, which is hereby incorporated by reference.

### TECHNICAL FIELD

This application relates generally to motion sensors for physical activity performance analysis.

### BACKGROUND

In various physical activities and sports, such as downhill snow sports, performance hinges on precise technique and the ability to make real-time adjustments. Traditional coaching methods often rely on in-person instruction or post-activity video analysis, which can be less effective due to delayed feedback and the inability to capture subtle movements accurately. While some modern systems utilize wearable sensors for performance analysis, they often require complex installation, modifications to equipment, and are sensitive to sensor misalignment during use.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a computer-implemented method for providing real-time performance feedback, comprising: a. receiving, at one or more processors, uncalibrated time-series motion data generated by one or more motion sensors coupled directly or indirectly to an athlete while performing a downhill snow sport that includes curved turns, the one or more motion sensors having an unknown rotational orientation relative to the athlete; b. feeding the uncalibrated time-series motion data into a calibration model executed by the one or more processors, the calibration model configured to determine an estimated rotational offset of the one or more motion sensors relative to a body-segment coordinate frame of the athlete; c. transforming, by the one or more processors, the uncalibrated time-series motion data to calibrated time-series motion data according to the estimated rotational offset, the calibrated time-series motion data aligned with the body-segment coordinate frame; and d. processing the calibrated time-series data, with the one or more processors, to determine one or more metrics for the athlete.

In one or more embodiments, the one or more motion sensors include(s) only a three-dimensional (3D) gyroscope and/or a 3D accelerometer. In one or more embodiments, determining the estimated rotational offset includes (i) aligning a vertical axis of the body-segment coordinate frame with gravity and (ii) selecting a rotation about the vertical axis that maximizes time-smoothed lateral acceleration during a plurality of the curved turns relative to fore-aft acceleration. In one or more embodiments, execution of the calibration model is triggered at turn boundaries detected from zero-crossings of roll, extrema of yaw rate, and/or sign changes in lateral acceleration.

In one or more embodiments, the one or more motion sensors is/are disposed in a motion-sensing device, and the method further comprises sending the uncalibrated time-series motion data from the motion-sensing device to a portable computer, the portable computer including the one or more processors. In one or more embodiments, the one or more motion sensors is/are disposed in a portable computer, the portable computer including the one or more processors.

The method of claim 6, wherein the portable computer comprises a smartphone. In one or more embodiments, the calibration model comprises a trained machine-learning (ML) model configured to determine the rotational offset of the one or more motion sensors directly from the uncalibrated time-series motion data. In one or more embodiments, the trained ML model was trained with a plurality of sets of randomly rotated time-series motion data, each set of randomly rotated time-series motion data having a respective known rotational offset relative to the body-segment coordinate frame. In one or more embodiments, the one or more motion sensors is/are disposed in a portable computer, the portable computer comprises a smartphone, and the uncalibrated time-series motion data used to train the trained ML model are only smartphone inertial data acquired during reference carved turns.

In one or more embodiments, the method further comprises processing the calibrated time-series data, with the one or more processors, to evaluate a performance of the athlete; and producing real-time sensory feedback to the athlete, the real-time sensory feedback corresponding to the performance of the athlete. In one or more embodiments, the method further comprises producing real-time sensory feedback to the athlete, the real-time sensory feedback corresponding to the one or more metrics. In one or more embodiments, the real-time sensory feedback includes a coaching cue.

In one or more embodiments, the calibration model comprises an attitude estimator or a quaternion estimator algorithm. In one or more embodiments, the body-segment coordinate frame includes yaw, pitch, and roll axes that are mutually orthogonal. In one or more embodiments, the calibration model is configured to independently determine a respective estimated rotational offset with respect to each of the yaw, pitch, and roll axes.

In one or more embodiments, the uncalibrated time-series motion data are received from a plurality of motion-sensing devices, each motion-sensing device including a respective one or more motion sensors, and the method further comprises: time-synchronizing the uncalibrated time-series motion data from the plurality of motion-sensing devices before the uncalibrated time-series motion data; and feeding time-synchronized uncalibrated time-series motion data into the calibration model to determine a respective estimated rotational offset of each motion-sensing device relative to the body-segment coordinate frame of the athlete. In one or more embodiments, the estimated rotational offsets for left and right devices are determined jointly using the time-synchronized uncalibrated time-series motion data to maximize inter-device symmetry of roll and yaw waveforms during a respective curved turn. In one or more embodiments, the motion-sensing devices include a first motion-sensing device associated with a first foot or a first leg on a first side of the athlete, and a second motion-sensing device associated with a second foot or a second leg on a second side of the athlete. In one or more embodiments, the calibration model is configured to predict the first and second sides.

In one or more embodiments, the method further comprises determining a state orientation estimate for the one or more motion sensors based, at least in part, on the estimated rotational offset. In one or more embodiments, the method further comprises determining, by the one or more processors and with the calibration model, a confidence value representing an uncertainty associated with the estimated rotational offset. In one or more embodiments, the state orientation estimate is updated using a dynamic state estimator that receives as inputs at least the confidence value and the estimated rotational offset. In one or more embodiments, the dynamic state estimator maintains independent sub-states and covariance for yaw, pitch, and roll and weights model updates inversely to a model-predicted axis-specific uncertainty. In one or more embodiments, the dynamic state estimator includes a Bayesian filter. In one or more embodiments, the Bayesian filter comprises a Kalman filter.

In one or more embodiments, the method further comprises injecting process noise into the dynamic state estimator, the process noise corresponding to an elapsed time since a last state orientation estimate and/or a difference between a current estimated rotational offset and a last estimated rotational offset. In one or more embodiments, the state orientation estimate includes three independent sub-states representing yaw, pitch, and roll axes. In one or more embodiments, the method further comprises transforming buffered uncalibrated time-series motion data for the downhill snow sport using the state orientation estimate so that historical motion data and current motion data share a common frame of reference. In one or more embodiments, the method further comprises persisting an updated state orientation estimate in non-volatile memory operably coupled to the one or more processors, at an end of a downhill snow sport session and initializing a subsequent downhill snow sport session with a persisted updated state orientation estimate.

In one or more embodiments, the method further comprises e. feeding the calibrated time-series motion data into the calibration model to determine an updated estimated rotational offset of the one or more motion sensors relative to the body-segment coordinate frame of the athlete; f. transforming, by the one or more processors, the calibrated time-series motion data to updated calibrated time-series motion data according to the updated estimated rotational offset; and g. repeating steps e and f iteratively wherein in a current iteration the calibrated time-series motion data fed into the calibration model in step b is the updated calibrated time-series motion data transformed in step f in a last iteration.

In one or more embodiments, the method further comprises triggering an execution of step b in response to a calibration event. In one or more embodiments, the calibration event includes a completion of a curved ski turn, a completion of a ski run, a transition onto a ski lift, and/or an explicit user input.

Another aspect of the invention is directed to a portable computer comprising: one or more processors; a plurality of motion sensors in communication with the one or more processors; non-volatile computer memory operably coupled to the one or more processors, the non-volatile computer memory storing computer-readable instructions that, when executed by the one or more processors, cause the one or more processors to: a. receive at least a set of uncalibrated time-series motion data generated by the one or more motion sensors while an athlete performs a downhill snow sport that includes curved turns, the one or more motion sensors having an unknown rotational orientation relative to the athlete; b. transform the set of uncalibrated time-series motion data to a set of calibrated time-series motion data by rotating the set of uncalibrated time-series motion data according to a current rotation estimate for the one or more motion sensors, the current rotation estimate determined relative to a body-segment coordinate frame of the athlete; c. determine, with a calibration model running on the one or more processors, a predicted rotation estimate for the set of calibrated time-series motion data relative to the body-segment coordinate frame of the athlete; d. combine the predicted rotation estimate and the current rotation estimate to form a model rotation estimate; e. determine an updated rotation estimate, relative to the body-segment coordinate frame of the skier, for the one or more motion sensors based at least in part on the model rotation estimate; and f. replace the current rotation estimate with the updated rotation estimate.

In one or more embodiments, the computer-readable instructions, when executed by the one or more processors, further cause the one or more processors to determine, with the calibration model, a model error estimate of the model rotation estimate. In one or more embodiments, in step e the updated rotation estimate for the one or more motion sensors is determined using as inputs the model error estimate, the model rotation estimate, and a current state error estimate for the current rotation estimate. In one or more embodiments, the computer-readable instructions, when executed by the one or more processors, further cause the one or more processors to determine the updated rotation estimate and the current state error estimate using a dynamic state estimator running on the one or more processors. In one or more embodiments, the dynamic state estimator comprises a Kalman filter, a Bayesian filter, or a recurrent neural network.

In one or more embodiments, the computer-readable instructions, when executed by the one or more processors, further cause the one or more processors to: g. determine, using the dynamic state estimator, an updated state error estimate using as inputs at least the model error estimate and the current state error estimate for the current rotation estimate; and h. replace the current state error estimate with the updated state error estimate. In one or more embodiments, the computer-readable instructions, when executed by the one or more processors, further cause the one or more processors to inject additional uncertainty into the dynamic state estimator, the additional uncertainty corresponding to an elapsed time since a last state orientation estimate and/or a difference between the current rotation estimate and a last rotation estimate. In one or more embodiments, the computer-readable instructions, when executed by the one or more processors, further cause the one or more processors to process a plurality of sets of the uncalibrated time-series motion data in a plurality of loops through steps a-h so as to iteratively update (a) the current rotation estimate of the one or more motion sensors and (b) the current state error estimate of the current rotation estimate. In one or more embodiments, each set of the uncalibrated time-series motion data represents a predetermined time period or a time between a last calibration event and current calibration event.

In one or more embodiments, the computer-readable instructions, when executed by the one or more processors, further cause the one or more processors to: analyze the set of calibrated time-series data to detect a curved turn performed by the athlete; transform at least a portion of the set of uncalibrated time-series motion data corresponding to the detected curved turn to respective calibrated time-series motion data using the updated rotation estimate determined in step e; and process the respective calibrated time-series motion data to analyze a performance of the athlete during the detected curved turn. In one or more embodiments, transforming the at least a portion of the set of uncalibrated data corresponding to the detected curved turn uses the updated rotation estimate determined after the detected curved turn, thereby aligning historical and current data to a common frame. In one or more embodiments, the computer-readable instructions, when executed by the one or more processors, further cause the one or more processors to produce a sensory feedback signal that generates sensory feedback to the athlete, the sensory feedback corresponding to the performance of the athlete during the turn.

In one or more embodiments, the portable computer comprises a smartphone. In one or more embodiments, the calibration model comprises a trained machine-learning (ML) model. In one or more embodiments, the trained ML model was trained with a plurality of sets of randomly rotated time-series motion data, each set of randomly rotated time-series motion data having a respective known rotational offset relative to the body-segment coordinate frame of the athlete.

Another aspect of the invention is directed to a system comprising: one or more motion-sensing devices, each motion-sensing device configured to be coupled at an unknown orientation to a skier, a ski boot, a ski binding, and/or a ski, each motion-sensing device including: one or more motion sensors configured to generate uncalibrated time-series motion data corresponding to a movement of the skier; first communications circuitry; one or more first processors coupled to the one or more motion sensors and the first communications circuitry. The system further comprises a portable computer in communication with the one or more motion-sensing devices, the portable computer comprising: second communications circuitry; one or more second processors coupled to the second communications circuitry; and non-volatile computer memory coupled to the one or more second processors, the second non-volatile computer memory storing computer-readable instructions that, when executed by the one or more second processors, cause the one or more second processors to: a. receive one or more sets of uncalibrated time-series motion data, each set of uncalibrated time-series motion data sent from a respective motion-sensing device; b. transform the one or more sets of uncalibrated time-series motion data to one or more sets of calibrated time-series motion data, respectively, by rotating each set of uncalibrated time-series motion data according to a respective current rotation estimate for each motion-sensing device relative to a body-segment coordinate frame of the skier; c. determine, with a calibration model running on the one or more second processors, for each motion-sensing device: a respective model rotation estimate for each set of calibrated time-series motion data relative to the body-segment coordinate frame of the skier; d. combine the respective relative model rotation estimate and the respective current rotation estimate to form a respective model rotation estimate for each motion-sensing device; e. determine a respective updated rotation estimate, relative to the body-segment coordinate frame of the skier, for each motion-sensing device based at least in part on the respective model rotation estimate; and f. replace the respective current rotation estimate for each motion-sensing device with the respective updated rotation estimate.

In one or more embodiments, the one or more motion-sensing devices comprises a plurality of the motion-sensing devices, and time-synchronization between the motion-sensing devices is/was established by estimating and removing round-trip latency through repeated timestamp exchanges and/or by detecting a common impulsive event captured by onboard microphones or accelerometers. In one or more embodiments, the one or more motion-sensing devices comprises at least a first motion-sensing device configured to be coupled to a first pant leg, a first ski boot, a first ski binding, or a first ski, and a second motion-sensing device configured to be coupled to a second pant leg, a second ski boot, a second ski binding, or a second ski.

In one or more embodiments, the computer-readable instructions, when executed by the one or more second processors, further cause the one or more second processors to determine, with the calibration model, a respective model error estimate of the respective model rotation estimate. In one or more embodiments, in step e the respective updated rotation estimate for each motion-sensing device is determined using as inputs the respective model error estimate, the respective model rotation estimate, and a respective current state error estimate for the respective current rotation estimate. In one or more embodiments, the computer-readable instructions, when executed by the one or more second processors, further cause the one or more second processors to determine the respective updated rotation estimate and the respective current state error estimate using a dynamic state estimator running on the one or more second processors.

In one or more embodiments, the dynamic state estimator comprises a Kalman filter, a Bayesian filter, or a recurrent neural network. In one or more embodiments, the computer-readable instructions, when executed by the one or more second processors, further cause the one or more second processors to: g. determine, using the dynamic state estimator, a respective updated state error estimate using as inputs at least the respective model error estimate and the respective current state error estimate for the respective current rotation estimate; and h. replace the respective current state error estimate with the respective updated state error estimate.

In one or more embodiments, the computer-readable instructions, when executed by the one or more second processors, further cause the one or more second processors to inject additional uncertainty into the respective updated state error estimate. In one or more embodiments, the computer-readable instructions, when executed by the one or more second processors, further cause the one or more second processors to process a respective plurality of the sets of uncalibrated time-series motion data from each motion-sensing device in a plurality of loops through steps a-h so as to iteratively update (a) the respective current rotation estimate for each motion-sensing device and (b) the respective updated error estimate of each motion-sensing device.

In one or more embodiments, the calibration model comprises a trained machine-learning (ML) model. In one or more embodiments, the trained ML model was trained using a plurality of sets of randomly rotated time-series motion data, each set of randomly rotated time-series motion data having a respective known rotational offset relative to the body-segment coordinate frame of the skier.

In one or more embodiments, the computer-readable instructions, when executed by the one or more second processors, further cause the one or more second processors to: analyze the one or more sets of calibrated time-series motion data to detect a ski turn performed by the skier; transform at least a portion of the one or more sets of uncalibrated time-series motion data corresponding to the ski turn to respective calibrated data time-series motion data using the respective updated rotation estimate determined in step e; and process the respective calibrated data time-series motion data to analyze a performance of the skier during the ski turn. In one or more embodiments, the computer-readable instructions, when executed by the one or more second processors, further cause the one or more second processors to produce a sensory feedback signal that generates sensory feedback to the skier, the sensory feedback corresponding to the performance of the skier during the ski turn.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1A shows a skier in position during a ski run according to one or more embodiments.

FIG. 1B shows a snowboarder in position during a snowboard run according to one or more embodiments.

FIG. 2A illustrates a sensor coordinate frame and a body-segment coordinate frame according to one or more embodiments.

FIG. 2B illustrates a reference coordinate frame and a body-segment coordinate frame according to one or more embodiments.

FIG. 3 is a block diagram of a motion-sensing device according to one or more embodiments.

FIG. 4 is a block diagram of a motion-sensing device according to one or more embodiments.

FIG. 5 is a block diagram of a real-time snow sport feedback system according to one or more embodiments.

FIG. 6 is a block diagram of a portable computer according to one or more embodiments.

FIG. 7 is a block diagram of a portable computer according to one or more embodiments.

FIG. 8 is a block diagram of a portable computer according to one or more embodiments.

FIG. 9 is a flow chart of a method for providing real-time performance feedback to a skier using one or more motion sensors having an unknown orientation according to one or more embodiments.

FIG. 10 is a flow chart of a computer-implemented method for estimating an orientation of one or more motion sensors according to one or more embodiments.

FIG. 11 is a flow chart of a computer-implemented method for analyzing skier performance and/or providing real-time performance feedback to a skier using uncalibrated motion sensors.

FIG. 12 is a flow chart of a method for automatically calibrating one or more motion sensors having an unknown orientation according to one or more embodiments.

FIG. 13 is a flow chart of a computer-implemented method for training a calibration model according to one or more embodiments.

FIG. 14 is a flow chart of a computer-implemented method 1400 for training a performance metric model for a downhill snow sport according to one or more embodiments.

FIG. 15 and FIG. 16 show examples of uncalibrated time-series motion data and calibrated time-series motion data, respectively.

### DETAILED DESCRIPTION

Motion sensors are coupled directly or indirectly to an athlete while performing a downhill snow sport such as skiing or snowboarding. The motion sensors can be enclosed in a motion-sensing device, a portable computer, or another device. The motion sensors are coupled at an unknown orientation relative to the athlete's body such that the raw uncalibrated time-series motion data produced by the motion sensors may be skewed (e.g., rotationally skewed) relative to the athlete's frame of reference. A calibration model is configured to predict the orientation of the motion sensors and any rotational offset, with respect to one or more axes, that may be needed to transform the uncalibrated time-series motion data to calibrated time-series motion data that is aligned with and/or corresponds to a body-segment frame of reference of the athlete. The calibration model can be or include a trained calibration machine-learning model or a calibration algorithm such as an attitude estimator (e.g., a complementary/gradient-descent filter), a quaternion estimator algorithm, or another calibration algorithm.

The calibrated time-series motion data can be analyzed to determine one or more metrics and/or real-time performance metrics of the athlete. Real-time sensory feedback corresponding to the real-time performance metrics can be provided, such as an indication of one or more performance scores and/or real-time instruction for improving the athlete's performance.

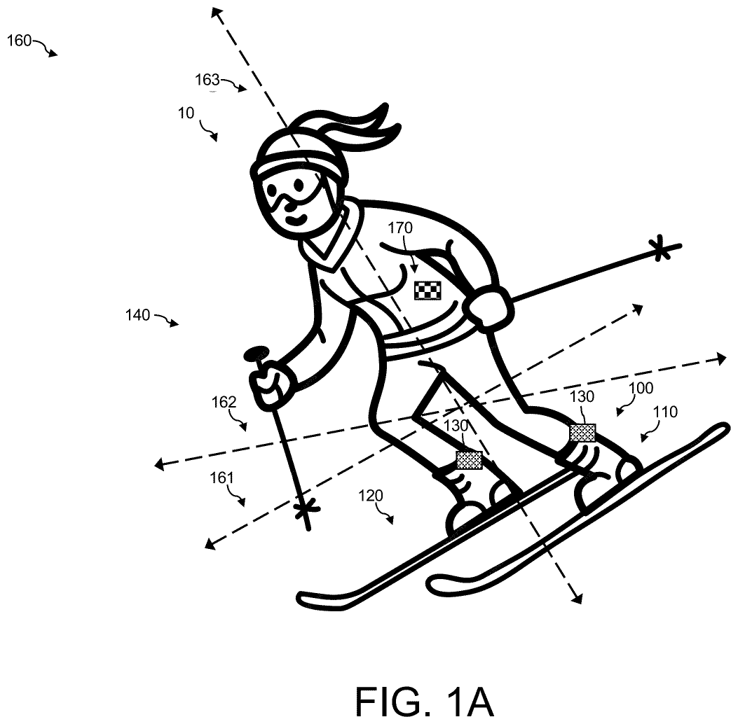

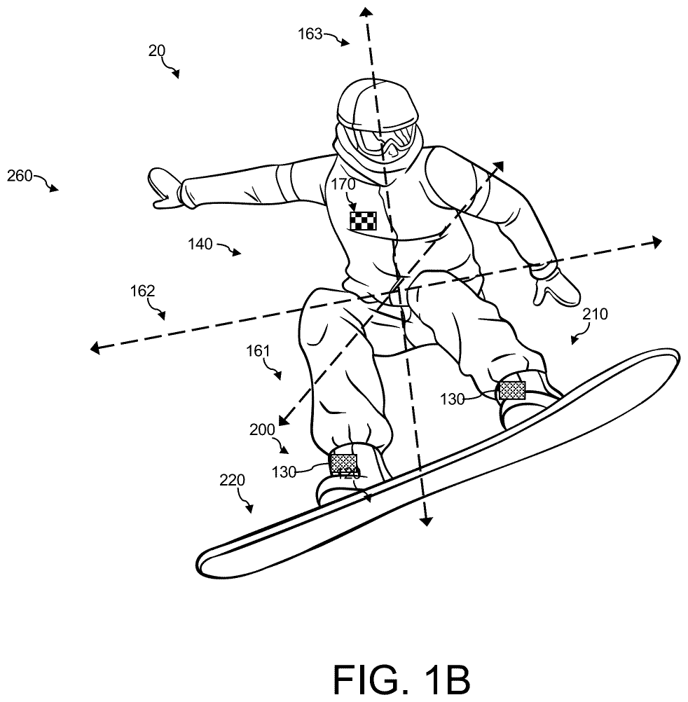

FIG. 1A shows a skier 10 in position during a ski run. The skier 10 is wearing ski boots 100 that are releasably attached to ski bindings 110 on skis 120. One or more motion-sensing devices 130 is/are attached to, mechanically coupled to, and/or disposed on/in a ski equipment such a ski boot 100, a ski binding 110, and/or a ski 120. Additionally or alternatively, one or more motion-sensing devices 130 can be attached to, mechanically coupled to, and/or disposed on/in an article of clothing 140 such as in a pocket (e.g., a jacket pocket or a leg pocket), a pant leg, or another portion of clothing. The skier 10 can be engaged in traditional downhill skiing, backcountry skiing or alpine touring (e.g., skinning), telemarking, and/or other downhill ski sports. During skiing, the skier 10 engages in curved turns that are generally in alternating directions.

In one or more embodiments, only one motion-sensing device 130 is attached to, mechanically coupled to, and/or disposed on/in (a) ski equipment such a ski boot 100, a ski binding 110, or a ski 120 or (b) an article of clothing 140. In one or more embodiments, two or more (e.g., a plurality of) sensing devices 130 are mechanically coupled to, and/or disposed on/in (a) ski equipment such a ski boot 100, a ski binding 110, and/or a ski 120 and/or (b) an article of clothing 140.

In one or more embodiments, a motion-sensing device 130 can be attached with a harness around a ski boot 100, clipped to a ski boot strap (e.g., a power strap) or buckle, attached on the outside of a ski boot 100 with adhesive, attached with a mount that is permanently affixed to a ski boot 100 (e.g., to the outside of a ski boot 100) with a mechanical interlock, such as bolt, a snap fit, or with adhesive, or slipped between the two flaps of the ski boot shell that buckle together.

In one or more embodiments, a first sensing device 130 is associated with a first lateral side (e.g., the left side) of the skier 10, for example attached or coupled to the left ski boot 100, and a second sensing device 130 is associated with a second lateral side (e.g., the right side) of the skier 10, for example attached or coupled to the right ski boot 100. For example, a first sensing device 130 can be attached to, mechanically coupled to, and/or disposed on/in a first ski boot 100 (e.g., the left ski boot) and a second sensing device 130 can be attached to, mechanically coupled to, and/or disposed on/in a second ski boot 100 (e.g., the right ski boot). In another example, a first sensing device 130 can be attached to and/or mechanically coupled to, and/or disposed on/in a first ski binding 110 (e.g., the left ski binding) and a second sensing device 130 can be attached to, mechanically coupled to, and/or disposed on/in a second ski binding 110 (e.g., the right ski binding). In another example, a first sensing device 130 can be attached to and/or mechanically coupled to, and/or disposed on/in a first ski 120 (e.g., the left ski) and a second sensing device 130 can be attached to, mechanically coupled to, and/or disposed on/in a second ski 120 (e.g., the right ski).

In another example, a first sensing device 130 can be attached to and/or mechanically coupled to, and/or disposed on a first leg of the skier 10 (e.g., the left leg), such as underneath a first ski pant leg (e.g., attached to, mechanically coupled to the first leg and/or disposed on the first leg directly or indirectly), on the first ski pant leg (e.g., attached to, mechanically coupled to, or disposed on an outside surface or an inside surface of first ski pant leg directly or indirectly), or in the first ski pant leg (e.g., attached to, mechanically coupled to, or disposed in a pocket on the first ski pant leg), and a second sensing device 130 can be attached to and/or mechanically coupled to, and/or disposed on a second leg of the skier 10 (e.g., the right leg), such as underneath a second ski pant leg (e.g., attached to, mechanically coupled to the second leg and/or disposed on the second leg directly or indirectly), on the second ski pant leg (e.g., attached to, mechanically coupled to, or disposed on an outside surface or an inside surface of second ski pant leg directly or indirectly), or in the second ski pant leg (e.g., attached to, mechanically coupled to, or disposed in a pocket on the second ski pant leg),

In another example, a first sensing device 130 can be attached to and/or mechanically coupled to, and/or disposed on a first side of the torso or waist of the skier 10 (e.g., the left side of the torso or waist), such as underneath the waist of ski pants, on a ski jacket (e.g., attached to, mechanically coupled to, or disposed on an outside surface or an inside surface of a first side of a ski jacket directly or indirectly), or in the ski jacket (e.g., attached to, mechanically coupled to, or disposed in a pocket on a first side of a ski jacket), and a second sensing device 130 can be attached to and/or mechanically coupled to, and/or disposed on a second side of the torso or waist of the skier 10 (e.g., the right side of the torso or waist), such as underneath the waist of ski pants, on a ski jacket (e.g., attached to, mechanically coupled to, or disposed on an outside surface or an inside surface of a second side of a ski jacket directly or indirectly), or in the ski jacket (e.g., attached to, mechanically coupled to, or disposed in a pocket on a second side of a ski jacket).

Combinations of any of the foregoing examples can be included such that multiple first sensing devices 130 can be attached to and/or mechanically coupled to, and/or disposed on multiple locations associated with the first lateral side (e.g., the left side) of the skier 10 and multiple second sensing devices 130 can be attached to and/or mechanically coupled to, and/or disposed on multiple locations associated with the second lateral side (e.g., the right side) of the skier 10.

Since the skier 10 wears the ski boots 100, the skis 120, and the clothing 140 during use of a motion-sensing device(s) 130, the/each motion-sensing device 130 is coupled directly or indirectly to the skier 10, to one or more ski boots 100, to one or more ski bindings 110, to one or more skis 120, and to clothing 140.

The skier 10 has a body-segment frame of reference or a body-segment coordinate frame (in general, body-segment coordinate frame 160) that is defined by mutually-orthogonal first, second, and third body axes 161-163. The first axis 161 can correspond to a roll axis. The second axis 162 can correspond to a pitch axis. The third axis 163 can be, on average, parallel to the direction of gravitational pull and can correspond to a yaw axis. The body axes 161-163 can intersect at the skier's waist or knees.

With respect to the foot or feet of the skier 10, the first axis 161 can correspond to the roll of the skis 120, the second axis 162 can correspond to the tipping of the foot or feet of the skier 10, and the third axis 163 can correspond to the rotation of the foot or feet of the skier 10 about the gravitational axis. With respect to the torso of the skier 10, the first axis 161 can correspond to the inclination of the torso of the skier 10, the second axis 162 can correspond to the tipping of the torso of the skier 10, and the third axis 163 can correspond to the rotation of torso about the gravitational axis.

The body-segment coordinate frame 160 can be defined with respect to other axes (e.g., other mutually-orthogonal axes) in other embodiments.

FIG. 1B shows a snowboarder 20 in position during a snowboard run. The snowboarder 20 is wearing snowboard boots 200 that are releasably attached to snowboard bindings 210 on a snowboard 220. The snowboarder 20 can be engaged in traditional downhill snowboard, backcountry or alpine splitboarding (e.g., skinning), and/or other downhill snowboard sports. During snowboarding, the snowboarder 20 engages in curved turns that are generally in alternating directions.

One or more motion-sensing devices 130 is/are attached to, mechanically coupled to, and/or disposed on/in a snowboard equipment such a snowboard boot 200, a snowboard binding 210, and/or a snowboard 220, for example in the same or similar manner as described above with respect to FIG. 1A. Additionally or alternatively, one or more motion-sensing devices 130 can be attached to, mechanically coupled to, and/or disposed on/in an article of clothing 140 such as in a pocket (e.g., a jacket pocket or a leg pocket), for example in the same or similar manner as described above with respect to FIG. 1. The snowboarder 20 has a body-segment coordinate frame 260 that can be the same as the body-segment coordinate frame 160 of the skier 10.

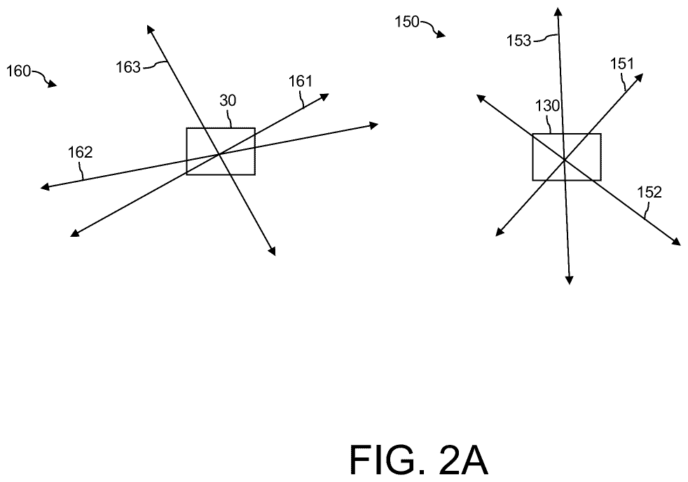

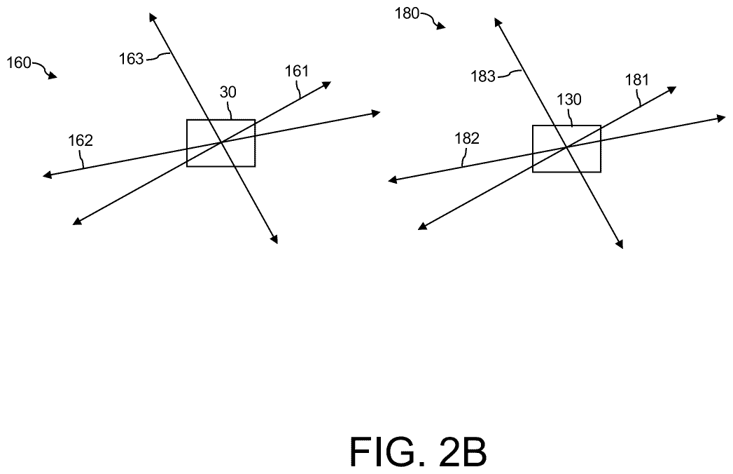

The motion-sensing device(s) 130 is/are configured to collect time-series motion data of the downhill snow sports athlete 30 (e.g., a skier 10 or a snowboarder 20) during a ski/snowboard run. The time-series motion data collected by a given motion-sensing device 130 is collected according to a sensor frame of reference or a sensor coordinate frame (in general, sensor coordinate frame) that is determined by the orientation of the motion-sensing device 130. For example, a motion-sensing device 130 has a sensor coordinate frame 150 that is defined by mutually-orthogonal first, second, and third sensor axes 151-153, for example as shown in FIG. 2A. The orientation of each motion-sensing device 130 is unknown relative to the snow sport athlete's body (e.g., the body-segment coordinate frame 160) such that each motion-sensing device 130 (e.g., the sensor coordinate frame 150) may not be aligned with (e.g., may be rotationally offset with respect to) the body-segment coordinate frame 160, for example as shown in FIG. 2A.

It is also noted that the orientation of each motion-sensing device 130 may change dynamically from day to day, from ski run to ski run, or even during a ski run (e.g., during a ski turn such as a carved ski turn, after a ski jump or trick, etc.). A motion-sensing device 130 produces or collects uncalibrated time-series motion data when the orientation of the motion-sensing device 130 (e.g., the sensor coordinate frame 150) relative to the body-segment coordinate frame 160 is not known. For the time-series motion data to be useful for the skier 10, such as to provide real-time feedback to the skier 10, the time-series motion data should reflect the motion of the skier 10 in the body-segment coordinate frame 160.

A calibration algorithm, such as a trained machine-learning (ML) model, an attitude estimator (e.g., a complementary/gradient-descent filter), a quaternion estimator algorithm, or another calibration algorithm that is configured to dynamically (e.g., in real time) determine/estimate the rotational orientation of a given motion-sensing device 130 relative to the body-segment coordinate frame 160. Using this estimated rotational orientation, the uncalibrated time-series motion data can be transformed from the sensor coordinate frame 150 to calibrated time-series motion data that is aligned (e.g., rotationally aligned) with the body-segment coordinate frame 160. Transforming the uncalibrated time-series motion data can include rotating the uncalibrated time-series motion data about one or more of the sensor axes 151-153. The calibrated time-series motion data can be defined with respect to a reference coordinate frame 180 that has mutually-orthogonal reference axes 181-183 that are aligned and/or parallel to axes 161-163, respectively, of the body-segment coordinate frame 160, for example as shown in FIG. 2B. The calibrated time-series motion data can represent the motion of the downhill snow sports athlete 30 with respect to first, second, and third mutually-orthogonal axes 181-183 that are parallel to and/or aligned with the first, second, and third axes 161-163, respectively. The first, second, and third axes 181-183 can be referred to as first, second, and third calibration axes 181-183 that define a calibration coordinate frame 180.

The calibration model can be stored and run in a motion sensing-device 130 and/or in a portable computer 170 (FIGS. 1A, 1B), such as a smartphone, that can be coupled directly or indirectly to the skier 10 or snowboarder 20, his/her equipment 100, 110, 120, 200, 210, 220, and/or his/her clothing 140.

The description is generally described with respect to skiing, but it is understood that it is equally applicable to other downhill snow sports such as snowboarding.

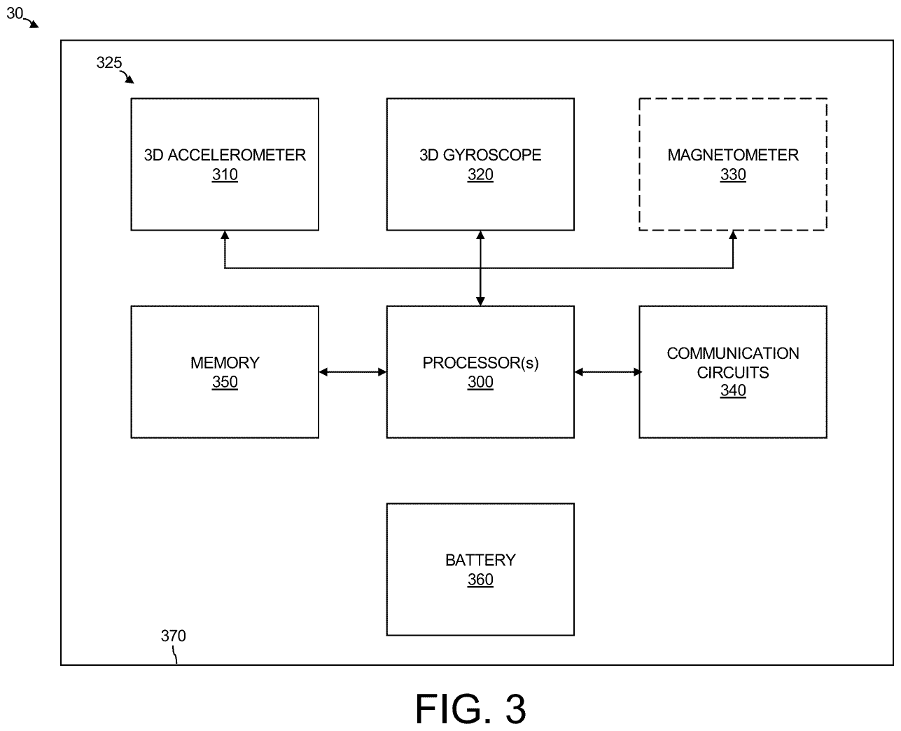

FIG. 3 is a block diagram of a motion-sensing device 30 according to one or more embodiments. The motion-sensing device 30 can be the same as a motion-sensing device 130.

The motion-sensing device 30 includes one or more hardware-based processors 300, a three-dimensional (3D) accelerometer 310, a 3D gyroscope 320, an optional magnetometer 330, communications circuitry 340, computer memory 350, a battery 360, and a housing 370. The 3D accelerometer 310 is configured to repeatedly measure (e.g., at a sampling frequency) acceleration forces along or parallel to three mutually-orthogonal axes, such as sensor axes 151-153. The 3D gyroscope 320 is configured to repeatedly measure (e.g., at a sampling frequency) angular velocity (e.g., rotation rate) about each of three mutually-orthogonal axes, such as about each sensor axis 151-153. The optional magnetometer 330 is configured to repeatedly measure (e.g., at a sampling frequency) the compass bearing or orientation of the motion-sensing device 30. In one or more embodiments, the motion-sensing device 30 can comprise an inertial measurement unit (IMU) 325 that includes the 3D accelerometer 310, the 3D gyroscope 320, and the optional magnetometer 330.

The processor(s) 300 can be configured to cause (e.g., via control signals) each of the 3D accelerometer 310, the 3D gyroscope 320, and the optional magnetometer 330 to repeatedly measure respective uncalibrated motion data. In addition, the processor(s) 300 can be configured to store motion data in computer memory 350 (e.g., volatile and/or non-volatile memory) and/or to transmit the motion data to another device or system using the communications circuitry 340. The communications circuitry 340 can be configured to transmit/broadcast the uncalibrated motion data wirelessly over a short-range (or personal) communications network using a short-range (or personal) communications protocol or standard such as Bluetooth and/or to transmit the motion data over a wide-area communications network (e.g., a cellular network and/or a WiFi network) using a wide-area communication/network protocol or standard such as a cellular or WiFi protocol (e.g., based on an IEEE 802.11 standard). Additionally or alternatively, the communications circuitry 340 can be configured to transmit/broadcast the uncalibrated motion data over a wired connection.

The computer memory 350 can store computer-readable program instructions that are configured to be executed by the processor(s) 300 to perform the tasks described herein.

The battery 360 is electrically coupled to the processor(s) 300, the 3D accelerometer 310, the 3D gyroscope 320, the optional magnetometer 330, the communications circuitry 340, and/or the computer memory 350 to provide electrical power thereto.

In one or more embodiments, the processor(s) 300 sends uncalibrated or uncorrected (e.g., raw) (in general, uncalibrated) motion data, measured/produced by the 3D accelerometer 310, the 3D gyroscope 320, and the optional magnetometer 330, to another device or system (e.g., an external device or system) that includes a trained ML model that is configured to dynamically (e.g., in real time) determine the orientation of the motion-sensing device 30 and to transform the uncalibrated motion data from a sensor coordinate frame 150 to and/or in alignment with a body-segment coordinate frame 160. For example, the uncalibrated motion data can be transformed from a sensor coordinate frame 150 to a calibration coordinate frame 180.

The processor(s) 300, the 3D accelerometer 310, the 3D gyroscope 320, the optional magnetometer 330, the communications circuitry 340, the computer memory 350, and the battery 360 are disposed in the housing 370. The housing 370 can be shatterproof and/or waterproof.

In one or more embodiments, the motion-sensing device 30 can include additional electrical components such as global-positioning circuitry (e.g., to track geospatial location using a global-positioning system (GPS)), one or more microphones, a barometer, an ultra-wideband sensor, and/or another electrical component.

In one or more embodiments, the motion sensors in the motion-sensing device 30 only include the 3D accelerometer 310 and/or the 3D gyroscope 320, such that the motion-sensing device 30 does not include global-positioning circuitry or a magnetometer 330.

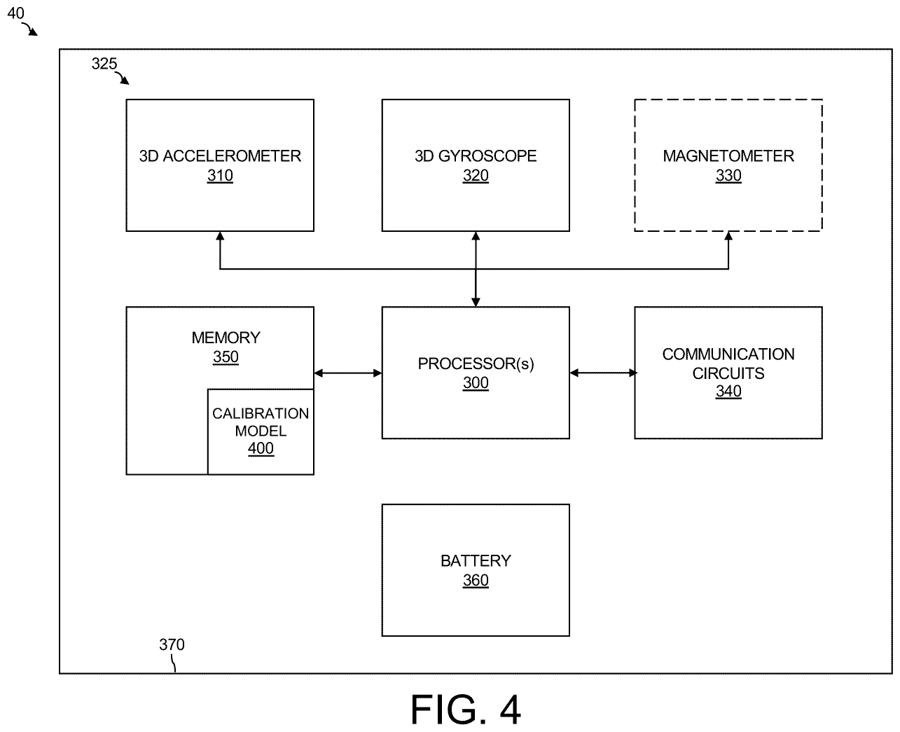

FIG. 4 is a block diagram of a motion-sensing device 40 according to one or more embodiments. The motion-sensing device 40 is the same as the motion-sensing device 30 except that the motion-sensing device 40 includes a calibration model 400 stored in the computer memory 350 (e.g., in non-volatile computer memory) and running on the processor(s) 300. The calibration model 400 can include or can be a trained machine-learning model, a calibration algorithm such as an attitude estimator (e.g., a complementary/gradient-descent filter), a quaternion estimator algorithm, and/or another calibration algorithm.

In one or more embodiments, the processor(s) 300 feeds uncalibrated motion data, measured/produced by the 3D accelerometer 310, the 3D gyroscope 320, and the optional magnetometer 330 to the calibration model 400. The calibration model 400 is configured to dynamically (e.g., in real time) determine the rotational orientation (e.g., a rotation orientation offset) of the motion-sensing device 40 relative to a body-segment coordinate frame 160. Using the rotational orientation determined using the calibration model 400, the processor(s) 300 can transform the uncalibrated motion data from a sensor coordinate frame 150 to calibrated motion data that is aligned with a body-segment coordinate frame 160, for example in a calibration coordinate frame 180. The processor(s) 300 output transformed time-series motion data that are aligned with the body-segment coordinate frame 160.

In one or more embodiments, the calibration model 400 can be configured to independently determine a respective rotational orientation estimate of the motion-sensing device 40 with respect to each axis 161-163 (e.g., each of the yaw, pitch, and roll axes) in the body-segment coordinate frame 160. In one or more embodiments, a respective confidence or error estimate can be determined for each rotational orientation estimate of the motion-sensing device 40 for each axis 161-163. An updated rotational orientation estimate can be determined for each axis based on the respective rotational orientation estimate and the respective confidence or error estimate for a respective axis, for example by applying a weight corresponding to the respective confidence or error estimate.

In one or more embodiments, the calibration model 400 can be configured to determine a single rotational orientation estimate of the motion-sensing device 40 with respect to axes 161-163. In one or more embodiments, a confidence or error estimate can be determined for the single rotational orientation estimate of the motion-sensing device 40 with respect to axes 161-163. In one or more embodiments, a respective confidence or error estimate can be determined for the single rotational orientation estimate of the motion-sensing device 40 with respect to each axis 161-163. An updated rotational orientation estimate can be determined for each axis based on the single rotational orientation estimate and the confidence or error estimate, for each or all axes 161-163, for example by applying a weight corresponding to the confidence or error estimate.

The processor(s) 300 transmit the transformed the motion data to another device or system, wirelessly or through a wired connection, using the communications circuitry 340.

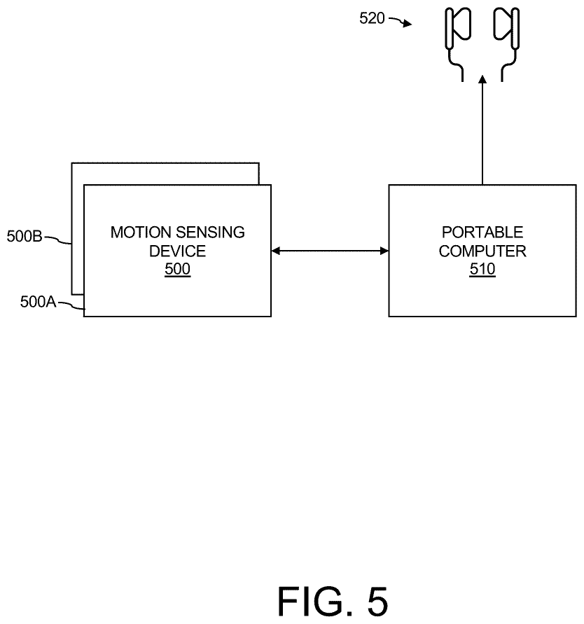

FIG. 5 is a block diagram of a real-time snow sport feedback system 50 according to one or more embodiments. The system 50 includes a plurality of motion-sensing devices 500 and a portable computer 510. First and second motion-sensing devices 500A, 500B are shown in FIG. 5, but it is understood that the system 50 can include additional motion-sensing devices 500 (e.g., 2 or more motion-sensing devices 500 such as 2-10 motion-sensing devices 500). In one or more other embodiments, the system 50 only includes one motion-sensing device 500. Each motion-sensing device 500 can be the same as a motion-sensing device 130, a motion-sensing device 30, or a motion-sensing device 40.

The motion-sensing devices 500 are in communication (e.g., wired or wireless communication) with the portable computer 510. The portable computer 510 can comprise or can be a smartphone, a tablet, or another portable computing device.

In one or more configurations of the system 50, the portable computer 510 receives uncalibrated time-series motion data from one or more motion-sensing devices 500, for example when each motion-sensing device 500 is the same as a motion-sensing device 30. The portable computer 510 includes a trained ML model that is configured to dynamically (e.g., in real time) determine the orientation of each motion-sensing device 500 and to transform the uncalibrated motion data from a respective motion-sensing device 500 from a sensor coordinate frame 150 to calibrated motion data that is defined with respect to a calibration coordinate frame 180 and/or aligned with a body-segment coordinate frame 160. In addition, the portable computer 510 is configured to analyze the calibrated motion data from the motion-sensing devices 500 to determine one or more ski metrics corresponding to the performance of the skier.

In one or more embodiments, the portable computer 510 is configured to time-synchronize the time-series motion data from two or more motion-sensing devices 500. For example, after calibration, time-synchronized calibrated time-series motion data from the motion-sensing devices 500 can be processed to determine one or more ski metrics corresponding to the performance of the skier. The time-series motion data can be time-synchronized using time stamps in the time-series motion data, using wireless signals between the two or more motion-sensing devices 500 and the portable computer 510, and/or using a common clock, such as an internet clock or in a global positioning system. For example, the communication of the current timestamp from the two or more motion-sensing devices 500 to a portable computer 510 can be performed multiple times to estimate and remove the effect of the round trip time to make and receive the request. In another example, a common external input source can be used by each motion-sensing device 500 to synchronize the time. For example, when each motion-sensing device 500 includes a microphone, a sound such as a clap can be used to time-synchronize the microphones. In another example, motion-sensing devices 500 can be banged together such that they experience a force or acceleration simultaneously.

In one or more other configurations of the system 50, the portable computer 510 receives calibrated motion data from the motion-sensing device 500, for example when each motion-sensing device is the same as a motion-sensing device 40. The portable computer 510 is configured to analyze the calibrated motion data from the motion-sensing devices 500 to determine one or more ski metrics corresponding to the performance of the skier.

In one or more embodiments, the portable computer 510 includes one or more motion sensors (e.g., an 3D accelerometer 310, a 3D gyroscope 320, and an optional magnetometer 330) such that the portable computer 510 comprises a motion-sensing device.

The portable computer 510 can display the ski metric(s) and/or other data on a display screen on or in communication with the portable computer 510 and/or can generate audio that the ski metric(s) and/or other data that be sent to a speaker such as headphones or earbuds 520 worn by the skier.

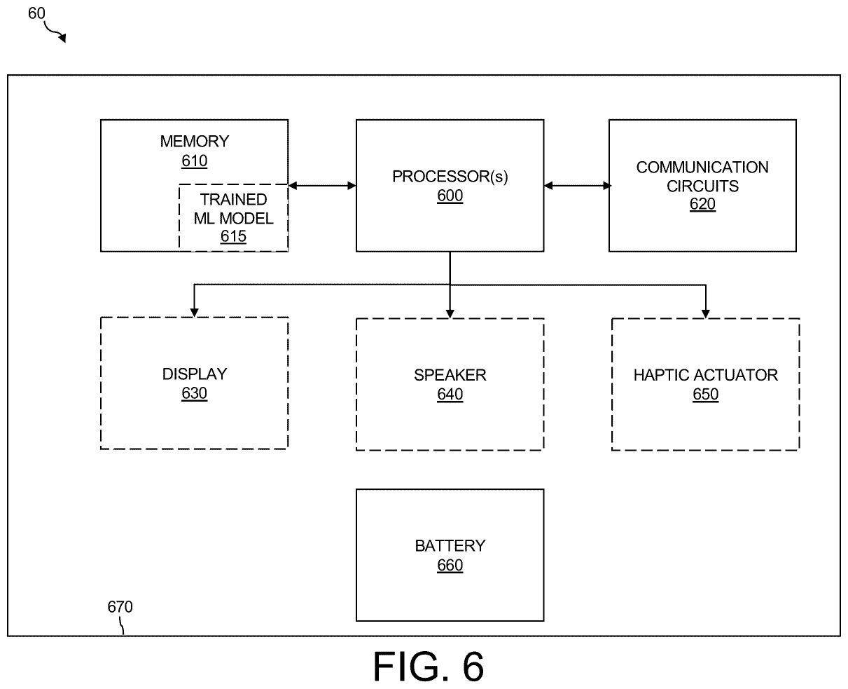

FIG. 6 is a block diagram of a portable computer 60 according to one or more embodiments. The portable computer 60 can be the same as a portable computer 510.

The portable computer 60 includes one or more hardware-based processors 600, computer memory 610, communications circuitry 620, an optional display 630, an optional speaker 640, an optional haptic actuator 650, a battery 660, and a housing 670. The communications circuitry 620 are configured to allow the portable computer 60 to receive calibrated motion data from one or more motion-sensing devices 500 (FIG. 5) (e.g., when each is of the one or more motion-sensing devices 500 is a respective motion-sensing device 40). The processor(s) 600 can store the calibrated motion data in the computer memory 610, which can include volatile and/or non-volatile computer memory. In one or more embodiments, the processor(s) 600 can send control signals to the one or more motion-sensing devices 500, using the communications circuitry 620, to request the one or more motion-sensing devices 500 to send the calibrated motion data (e.g., a pull request).

The processor(s) 600 is/are configured to process and/or analyze the calibrated motion data to determine one or more ski performance metrics corresponding to the performance of the skier. For example, the processor(s) 600 can calculate kinematics of the ski trajectory including detecting the initiation of ski turns (e.g., carved ski turns) and/or the radii of ski turns. The ski performance metric(s) can include evaluation of: the turn shape, for example by comparing the progression of yaw angles to a target reference or by measuring the smoothness of the rate of change of yaw; how parallel the skis are, for example if two sensors, one on each boot are used, the degree to which the yaw is similar for each ski; the maximum edge angle of the ski; the edging similarity between skis, defined as how similar each ski rolls during a turn; the lateral (centripetal) acceleration of the turn, sometimes called turn G-force; and/or other ski performance metric(s).

In one or more embodiments, the calculation of ski performance metric(s) can be further disclosed and/or described in U.S. Pat. No. 8,612,181, titled “Wireless System For Monitoring And Analysis Of Skiing,” U.S. Pat. No. 9,968,840, titled “Method And Apparatus To Provide Haptic And Visual Feedback Of Skier Foot Motion And Forces Transmitted To The Ski Boot,” and/or U.S. Pat. No. 11,328,620, titled “System And Method For Physical Activity Performance Analysis,” which are hereby incorporated by reference. To the extent any terms in a document incorporated by reference are used in a different manner than in this application, the meaning used in this application shall apply.

In one or more embodiments, the ski performance metric(s) can be determined by feeding the calibrated motion data into an optional trained ML model 615 that is stored on the computer memory 610 and running on the processor(s) 600. The trained ML model 615 can be trained previously on a training dataset that includes known ski performance metric(s) and reference calibrated motion data.

In one or more embodiments, the ski performance metric(s) and/or other data can be provided (e.g., by producing one or more sensory feedback signals) as sensory feedback to the skier, such as graphically on the optional display 630, audibly over an optional speaker 640, and/or haptically using the optional haptic actuator 650. Additionally or alternatively, the ski performance metric(s) and/or other data can be sent (e.g. using the communications circuitry 620) to another device associated with the skier, such as headphones/earbuds 520 (FIG. 5), a wearable haptic feedback device, augmented reality glasses, and/or another device.

The processors 600, the computer memory 610, the communications circuitry 620, the optional display 630, the optional speaker 640, the optional haptic actuator 650, and the battery 660 are disposed in the housing 670. The housing 670 can be shatterproof and/or waterproof.

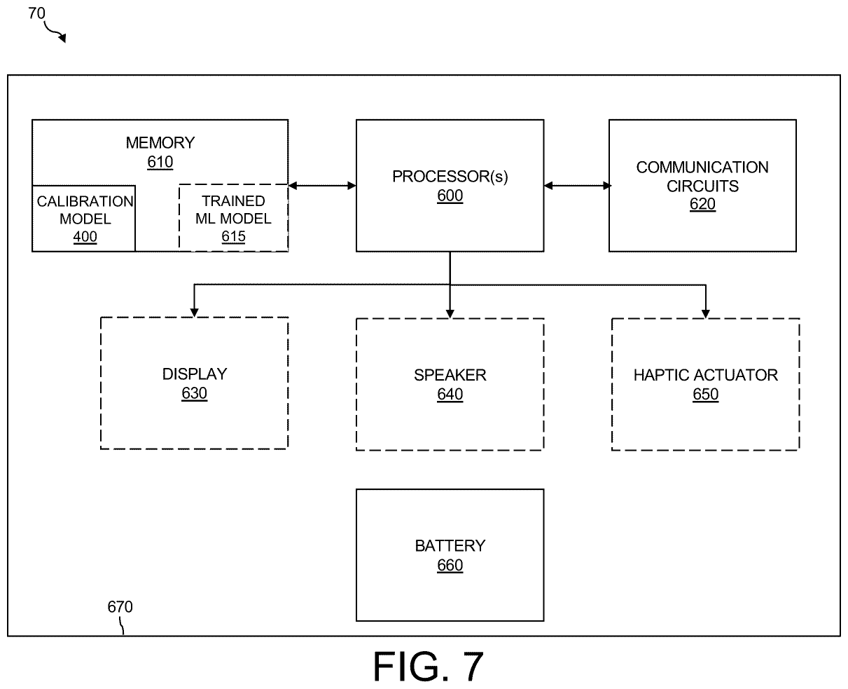

FIG. 7 is a block diagram of a portable computer 70 according to one or more embodiments. The portable computer 70 is the same as the portable computer 60 except that the portable computer 70 includes a calibration model 400 stored in the computer memory 610 (e.g., in non-volatile computer memory) and running on the processor(s) 600.

The communications circuitry 620 are configured to allow the portable computer 70 to receive uncalibrated motion data from the one or more motion-sensing devices 500 (FIG. 5) (e.g., when each is of the one or more motion-sensing devices 500 is a respective motion-sensing device 30). The processor(s) 600 can store the uncalibrated motion data in the computer memory 610. The processor(s) 600 is/are configured to feed the uncalibrated motion data into the calibration model 400 that is configured to dynamically (e.g., in real time) determine the rotational orientation of each of the motion-sensing device(s) relative to a body-segment coordinate frame. The processor(s) 600 can use the rotational orientation, determined using the calibration model 400, to transform the uncalibrated motion data from a sensor coordinate frame 150 to calibrated motion data that is aligned with a body-segment coordinate frame 160 and/or defined in a calibration coordinate frame 180, as described herein.

In one or more embodiments, the calibration model 400 can be configured to independently determine the rotational orientation of the motion-sensing device 40 with respect to each axis 161-163 (e.g., each of the yaw, pitch, and roll axes) in the body-segment coordinate frame 160.

The processor(s) 600 can process and/or analyze the calibrated motion data to determine one or more ski performance metrics corresponding to the performance of the skier. In one or more embodiments, the ski performance metric(s) can be determined by feeding the calibrated motion data into an optional trained ML model 615 that is stored on the computer memory 610 and running on the processor(s) 600.

To avoid confusion and for case of discussion herein, the trained ML model 400 can alternately be referred to as a trained calibration model (e.g., a trained calibration model 400) and the optional trained ML model 615 can alternately be referred to as a trained performance metric model (e.g., a trained performance metric model 615).

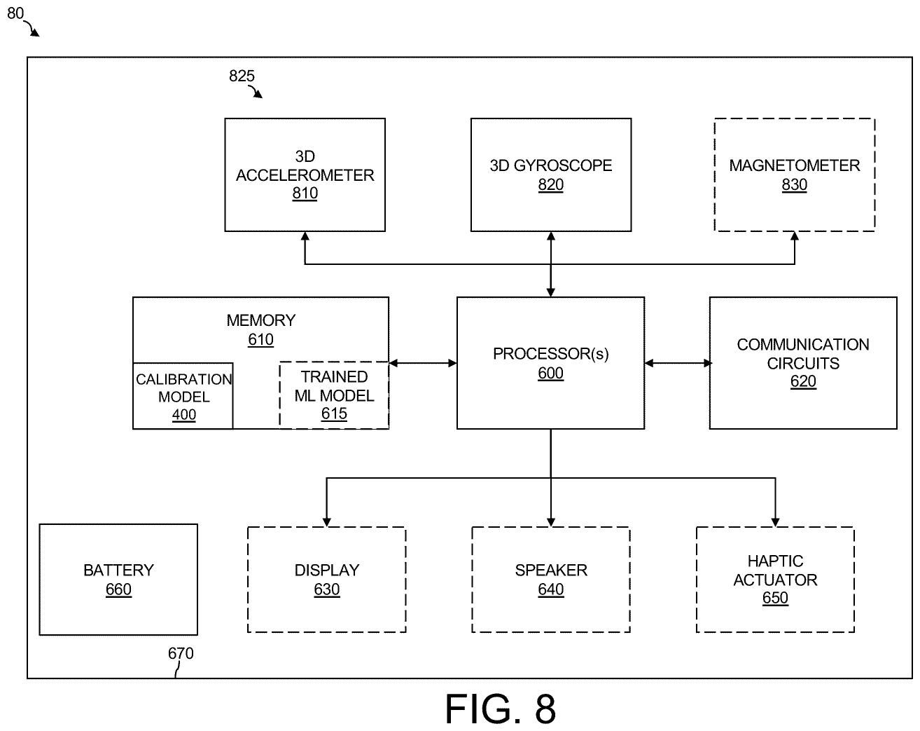

FIG. 8 is a block diagram of a portable computer 80 according to one or more embodiments. The portable computer 80 is the same as the portable computer 70 except that the portable computer 80 includes a 3D accelerometer 810, a 3D gyroscope 820, an optional magnetometer 830, such that the portable computer 80 comprises a motion-sensing device. The 3D accelerometer 810, the 3D gyroscope 820, and the optional magnetometer 830 can be the same as the 3D accelerometer 310, the 3D gyroscope 320, and the optional magnetometer 330, respectively. In one or more embodiments, the portable computer 80 can include an IMU 825 that includes the 3D accelerometer 810, the 3D gyroscope 820, and the optional magnetometer 830.

The 3D accelerometer 810, the 3D gyroscope 820, and the optional magnetometer 830 is/are configured to repeatedly produce (e.g., at a sampling frequency) motion data that reflect the motion of a skier during a ski run. The respective motion produced the motion sensors (e.g., the 3D accelerometer 810, the 3D gyroscope 820, and the optional magnetometer 830) is uncalibrated, for example because the portable computer 80 is coupled to the skier and/or the skier's equipment at an unknown orientation relative to the skier's body and to a body-segment coordinate frame 160.

The processor(s) 600 is/are configured to feed the uncalibrated motion data into the calibration model 400 to determine the rotational offset of the portable computer 80 relative to a body-segment coordinate frame 160. The processor(s) 600 can transform the uncalibrated motion data into calibrated motion data using the rotational offset determined using the calibration model. The processor(s) 600 can process and/or analyze the calibrated motion data to determine one or more ski metrics and/or ski performance metrics corresponding to the performance of the skier. In one or more embodiments, the ski performance metric(s) can be determined by feeding the calibrated motion data into an optional trained performance metric model 615 that is stored on the computer memory 610 and running on the processor(s) 600.

In one or more embodiments, the portable computer 80 can receive additional motion data from other motion sensors, such as from one or more motion-sensing devices 500 (FIG. 5). In one or more embodiments, the portable computer 80 can function as a standalone device that does not receive additional motion data from other motion sensors.

The processors 600, the computer memory 610, the communications circuitry 620, the optional display 630, the optional speaker 640, the optional haptic actuator 650, the battery 660, the 3D accelerometer 810, the 3D gyroscope 820, and the optional magnetometer 830 are disposed in the housing 670.

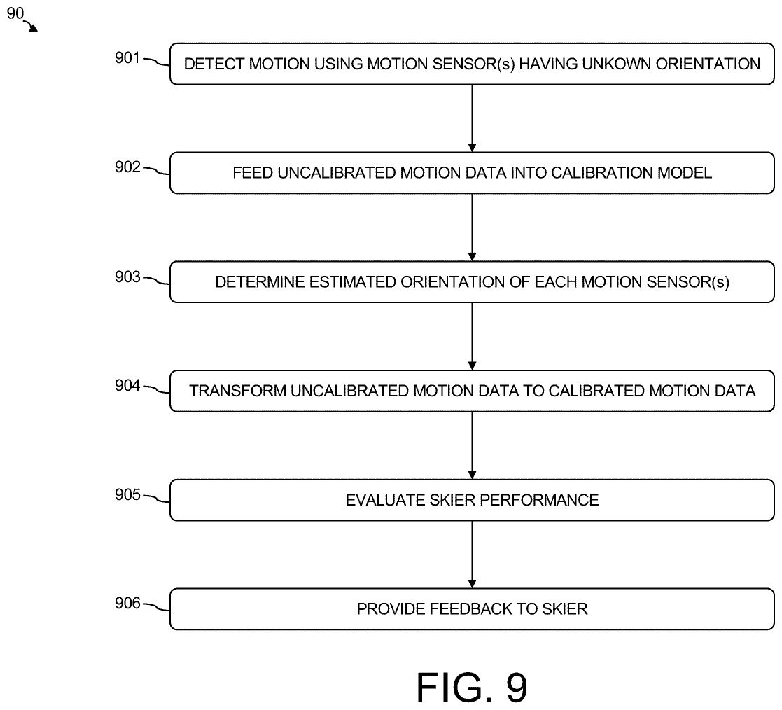

FIG. 9 is a flow chart of a method 90 for providing real-time performance feedback to a skier using one or more motion sensors having an unknown orientation according to one or more embodiments. Method 90 can be performed by a motion-sensing device 30, 40, 500 and/or by a portable-computer 60, 70, 80, 510.

In step 901, a skier's motion is detected or measured using one or more motion sensors. The motion sensor(s) is/are coupled to a skier, to an article of clothing worn by the skier, and/or to a skier's equipment, such as a ski boot. The motion sensor(s) has/have an unknown orientation relative to the skier's body and to a body-segment coordinate frame 160 such that the motion sensor(s) generate uncalibrated motion data. The motion sensor(s) can include a 3D accelerometer, a 3D gyroscope, and/or a magnetometer. The motion sensor(s) can include and/or be disposed in one or more motion-sensing devices 30, 40, and/or 500 and/or in a portable computer 80.

The uncalibrated data can represent a time interval (e.g., 10-30 seconds), a ski run, a portion of a ski run (e.g., a ski turn such as a carved ski turn), and/or another time interval or event.

In step 902, the uncalibrated motion data from each of the motion sensor(s) are fed into a calibration model 400 that is stored in non-volatile memory and running on one or more processors.

When the motion sensor(s) is/are disposed in one or more motion-sensing devices 30, 500 the uncalibrated motion data are sent from a respective motion-sensing device 30, 500 to a portable computer 70, 80 on which the calibration algorithm 400 is stored and run. The uncalibrated motion data sent to a portable computer 80 can be processed/fed into the calibration model 400 together with or separately from any uncalibrated motion data collected by motion sensor(s) on the portable computer 80. The uncalibrated motion data collected from the motion-sensing devices 30 and the uncalibrated motion data collected by motion sensor(s) on the portable computer 70, 80 can be time-synchronized before being processed/fed into the calibration model 400. When the motion sensor(s) is/are disposed in one or more motion-sensing devices 40 or in a portable computer 80, the uncalibrated motion data from a respective device can be fed into a calibration algorithm 400 that is stored and run on the respective motion-sensing device 40 or on the portable computer 80, respectively.

In one or more embodiments, the motion sensors are in a first motion-sensing device disposed or attached on a first side of the athlete (e.g., a left motion-sensing device disposed or attached on a left side of the athlete) and in a second motion-sensing device disposed or attached on a second side of the athlete (e.g., a right motion-sensing device disposed or attached on a right side of the athlete). The uncalibrated motion data from the first and second (e.g., left and right) motion-sensing devices can be time-synchronized before being processed/fed into the calibration model 400, for example running on a portable computer 80 in communication with the first and second (e.g., left and right) motion-sensing devices. In one or more embodiments, the estimated rotational offsets for the first and second (e.g., left and right) motion-sensing devices are determined jointly using the time-synchronized uncalibrated time-series motion data to maximize inter-device symmetry of roll and yaw waveforms during a respective/same turn (e.g., a curved turn).

In step 903, a respective estimated or predicted orientation (e.g., rotational orientation) of each of the motion sensor(s), motion-sensing devices, and/or portable computer(s) is determined using the calibration model 400, running on the processor(s), and the respective uncalibrated motion data from a respective motion sensor, a respective motion-sensing device, and/or a respective portable computer. The estimated/predicted orientation of a respective motion sensor, respective motion-sensing device, and/or a respective portable computer is determined relative to the skier's body such as relative to a body-segment coordinate frame 160.

When the motion sensor(s) is/are disposed in one or more motion-sensing devices 30, the estimated or predicted orientation of each motion-sensing device 30 is determined using the calibration algorithm 400 running on the same portable computer 70, 80 as in step 902. When the motion sensor(s) is/are disposed in one or more motion-sensing devices 40 or in a portable computer 80, the estimated or predicted orientation of each of the motion sensor(s) or motion-sensing device is determined using the calibration algorithm 400 running on the same/respective motion-sensing device(s) 40 or the same portable computer 80, respectively, as in step 902.

In one or more embodiments, the calibration model 400 can be configured to independently determine the rotational orientation of the motion-sensing device 30, 40 or portable computer 70, 80 with respect to each axis 161-163 (e.g., each of the yaw, pitch, and roll axes) in the body-segment coordinate frame 160.

When the calibration model 400 is or comprises a trained ML model, the trained model is configured to determine the estimated/predicted orientation of the motion sensor(s) (e.g., in a motion-sensing device or in a portable computer) directly from the uncalibrated time-series motion data. When the calibration model 400 is or comprises a calibration algorithm, an attitude estimator (e.g., a complementary/gradient-descent filter such as Madgwick) can be used to compute, over time, a rotational orientation between the sensor coordinate frame 150 and a gravity-aligned frame, represented as a quaternion or any equivalent rotation parameterization. During skiing the skier's body is, on average across turns, substantially aligned with gravity (e.g., the direction of gravitational pull). Therefore, this step establishes the z-axis (e.g., axis 163) of the body leaving an unobserved rotation about yaw. To determine the remaining rotation about the yaw axis to correct the roll and pitch axis (e.g., axes 161 and 162, respectively), the system exploits the lateral (centripetal) acceleration generated during ski turns (e.g., carved ski turns), which is typically larger in magnitude, when temporally smoothed and averaged, than fore-aft acceleration. Thus one can find this rotation by finding the rotation that maximizes the smoothed lateral (e.g., centripetal) acceleration (in the direction of the pitch axis) during skiing (e.g., during a plurality of carved turns) relative to fore-aft acceleration.

In step 904, the respective uncalibrated motion data from each of the motion sensor(s) motion-sensing device(s), and/or portable computer(s) are transformed from a respective sensor coordinate frame 150 to respective calibrated motion data that are aligned with the body-segment coordinate frame 160 and/or defined according to a respective calibration coordinate frame 180. The respective uncalibrated motion data are transformed using a respective estimated/predicted rotational orientation, relative to a body-segment coordinate frame 160, of the respective motion sensor.

When the motion sensor(s) is/are disposed in one or more motion-sensing devices 30, the uncalibrated motion data from a respective motion-sensing device 30 are transformed using one or more processor(s) 600 in the same portable computer 70, 80 as in step 903. When the motion sensor(s) is/are disposed in one or more motion-sensing devices 40 or in a portable computer 70, 80, the uncalibrated motion data from each motion sensor(s) or motion-sensing device is determined using one or more processor(s) 300 on the same/respective motion-sensing device(s) 40 or one or more processor(s) 600 on the same portable computer 70, 80, respectively, as in step 903. In one or more alternative embodiments, when the motion sensor(s) is/are disposed in one or more motion-sensing devices 40, a respective motion-sensing device can send the uncalibrated motion data and the estimated/predicted orientation to a portable computer 70, 80 to transform the uncalibrated motion data to calibrated motion data.

In optional step 905, the calibrated motion data are processed and/or analyzed, using one or more processors, to evaluate metrics and/or skier's performance for the time interval or event. In one or more embodiments, the calibrated motion data can be processed and/or analyzed by feeding the calibration motion data into a trained performance metric model 615. The skier's performance can be represented as one or more metrics and/or scores.

When the uncalibrated motion data are transformed by a portable computer 60, 70, 80 in step 904, the one or more processor(s) 600 on the same 60, 70, 80, respectively, can process and/or analyze the calibrated motion data in step 905, for example using a trained performance metric model 615 running on the respective one or more processor(s) 600. When the uncalibrated motion data are transformed by a respective motion-sensing device 40, the respective motion-sensing device 40 can send the calibrated motion data to a portable computer 60, 70, 80 to process and/or analyze the calibrated motion data using one or more processor(s) 600 on the portable computer 60, 70, 80, for example using a trained performance metric model 615 running on the one or more processor(s) 600.

In optional step 906, feedback regarding the skier's performance is provided to the skier. The feedback can include sensory feedback that can be visual, audible, haptic, and/or other sensory feedback. The feedback and/or sensory feedback can include or represent one or more metrics and/or scores, and/or can include instructions (e.g., real-time coaching feedback) relating to the skier's performance.

The feedback and/or sensory feedback can be provided using a display 630, a speaker 640, and/or a haptic actuator 650 in the portable computer 60, 70, 80 or through an external feedback device such as headphone/earbuds 520 that is in communication with the portable computer 60, 70, 80.

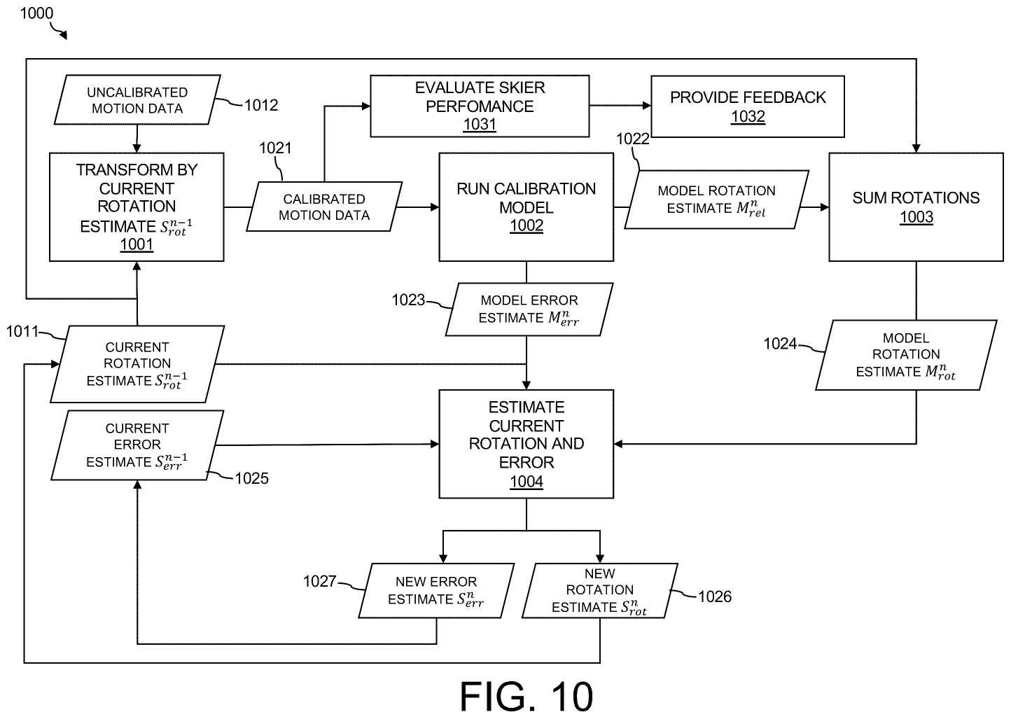

FIG. 10 is a flow chart of a computer-implemented method 1000 for estimating an orientation of one or more motion sensors according to one or more embodiments. Additionally or alternatively, the method 1000 can provide real-time performance feedback to a skier. Method 1000 can be performed iteratively and/or continuously, for example after a predetermined time interval (e.g., every 10 seconds, every 20 seconds, every 30 seconds, or another time interval) and/or after (e.g., in response to) a predetermined calibration event, such as the completion of a ski turn (e.g., a carved ski turn) or the completion of a ski run. Predetermined thresholds can be used to prevent the method 1000 from running too often. Method 1000 can be performed by a motion-sensing device 40, 500 and/or by a portable-computer 510, 60, 70, 80.

In step 1001, uncalibrated motion data 1012 are transformed to calibrated motion data 1021 by rotating the uncalibrated motion data 1012 using a current (or most recent) rotation estimate 1011. The uncalibrated motion data 1012 represents time-series motion data collected and/or output by one or more motion sensors in a common motion-sensing device (e.g., a motion-sensing device 30, 40) or in a portable computer that includes one or more motion sensors (e.g., a portable computer 80). The uncalibrated motion data 1012 can represent a current time period, such as a current time interval (e.g., the last 10 seconds, the last 20 seconds, the last 30 seconds, or another time interval) and/or the time period between predetermined calibration events (e.g., between the completion of a last ski turn (e.g., a last carved ski turn) and the completion of a current ski turn (e.g., a current carved ski turn), or from the start of a current ski run to a completion or break in the current ski run). Thus, a time period can comprise a predetermined time interval or the time between consecutive first and second predetermined calibration events. The current time period can be represented as time period n. The last/previous time period can be represented as time period n−1.

The current rotation estimate 1011 was determined using uncalibrated motion data 1012 collected and/or output by the one or more motion sensors in the same common motion-sensing device or portable computer in the last time period n−1 and as further described herein. The current rotation estimate 1011 can include a respective rotation (e.g., absolute rotation) with respect to first, second, and/or third sensor axes 151-153, which can be represented as an array or matrix (e.g., an array/matrix of vectors), to transform the uncalibrated motion data 1012 to calibrated motion data 1021 that are aligned with a body-segment coordinate frame 160 of the athlete/skier (e.g., defined according to a calibration coordinate frame 180). The current rotation estimate 1011 can be represented in other ways such as quaternions or another rotation representation. The current rotation estimate can be represented as

$${S}_{rot}^{n - 1}$$

where S indicates the state of the motion-sensing device or portable computer, such that

$${S}_{rot}^{n - 1}$$

can indicate the current state of the motion-sensing device or portable computer using uncalibrated motion data leading up to and including time period n−1 by the motion-sensing device or portable computer. In one or more other embodiments, the current rotation estimate 1011 can include three vectors to represent the rotation with respect to the first, second, and/or third sensor axes 151-153.

The rotation estimate with respect to each sensor axis 151-153 can be determined independently such that a rotation estimate for each of the yaw, pitch, and roll axes in the body-segment coordinate frame 160 can be determined.

In one or more embodiments, the uncalibrated motion data 1012 can be transformed to calibrated motion data 1021 as described below.

Let S represent a sensor-fixed frame and B a body-segment frame, then the rotation of motion data from S→B can be achieved in multiple ways. The example here uses quaternions, but an equivalent rotation-matrix implementation or other methods can be used.

Let q_{BS} represent a unit quaternion that maps S→B and let q_{BS} represent its inverse. For any sensor-frame vector, vs (e.g., the acceleration vector, as, or rate of rotation vector, ω_{S}) the calibrated vector in the body-segment frame is obtained by: (1) transforming the sensor-frame vector to a pure quaternion, p_{S}=[0, v_{S}]; (2) rotating with the quaternion to form the pure quaternion in the body-segment frame, p_{B}=q_{BS}*p_{S}*q_{SB}, where * represents quaternion multiplication; and (3) extracting the rotated vector, v_{B}=vec(p_{B}), where vec(·) extracts the vector part of the quaternion. For any orientation from in the sensor-frame, q_{S}, that must be rotated into the body-segment frame, q_{B}=q_{S}*q_{SB}.

In step 1002, the calibrated motion data 1021 are input or fed into a calibration model (e.g., a calibration model 400) to determine the rotational misalignment (e.g., rotational offset), if any, between the calibrated motion data 1021 and the body-segment coordinate frame 160 with respect to one or more axes (e.g., one or more sensor axes 151-153). The calibrated motion data 1021 may be rotationally misaligned/rotationally offset with respect to the body-segment coordinate frame 160 when the motion-sensing device or portable computer moved or shifted, relative to the body-segment coordinate frame 160, since the last time period n−1, or the previous rotation estimate was inaccurate.

The output of step 1002 is a model rotation estimate 1022 for the current time period n. The model rotation estimate can be represented as

$${M}_{rel}^{n}$$

and can include an array/matrix of rotations (e.g., defined as respective vectors), with respect to each sensor axis, about which the calibrated motion data 1021 (e.g., and the corresponding calibration coordinate frame 180) are estimated to be rotated to be in alignment with the body-segment coordinate frame 160. A rotation of 0 degrees indicates that it is estimated that the calibrated motion data 1021 does not need to be rotated with respect to a given axis to be in alignment with the body-segment coordinate frame 160. The model rotation estimate 1022 can be represented as a single rotation matrix or as separate (e.g., independent) model rotation estimates for each sensor axis 151-153. The model rotation estimate 1022 can be represented in other ways such as quaternions or another rotation representation.

In one or more embodiments, the calibration model can output an optional model error estimate

$${M}_{err}^{n}$$

1023 as an output of step 1002. The model error estimate

$${M}_{err}^{n}$$

1023 can be provided as a single value (e.g., in the range of 0 to 1) that represents the error or confidence level of the calibration model in the model rotation estimate 1022, for example when the model rotation estimate is represented as a single rotation matrix or a complex rotation. Alternatively, the model error estimate

$${M}_{err}^{n}$$

1023 can be provided as separate/independent values that represent the respective error or confidence level in the model rotation estimate 1022 with respect to each sensor axis. The respective error/confidence level in the model rotation estimate 1022 with respect to each sensor axis can be provided regardless of whether the model rotation estimate 1022 is represented as a single rotation matrix or as separate (e.g., independent) model rotation estimates for each sensor axis 151-153.

In one or more embodiments, the calibration model can determine the respective error/confidence level in the model rotation estimate 1022 based, at least in part, on the variance or standard deviation of the uncalibrated motion data with respect to the yaw, pitch or roll angles (e.g., with respect to sensor axes 151-153). In one more embodiments, when the variance is low (e.g., a motion-sensing device is stationary or has little movement), the error estimate will be large. In one more embodiments, when the variance is high (e.g., a motion-sensing device moves significantly during skiing), the error estimate will be low. The calibration model can determine the respective error/confidence level in the model rotation estimate 1022 using other methods and/or algorithms in additional or alternative embodiments.

In step 1031, the calibrated motion data 1021 can be processed and/or analyzed to evaluate or determine the skier's performance for the current time period n. In one or more embodiments, the skier's performance can be determined using a trained performance metric model 615. In step 1032, visual, audible, haptic, and/or other feedback (e.g., sensory feedback and/or other feedback) can be provided to the skier based partially or wholly on the skier's performance for the current time period n. Steps 1031 and 1032 and be the same as steps 905 and 906, respectively. Steps 1031 and 1032 can be performed in parallel with, before, or after step 1002.

In one or more embodiments, the calibrated motion data 1021 from two or more motion-sensing devices for the current time period n can be time-synchronized to form time-synchronized calibrated time-series motion data. The time-synchronized calibrated time-series motion data for the current time period n can be processed and/or analyzed in step 1031 to determine or more ski metrics corresponding to the performance of the skier. Time-synchronizing the calibrated time-series motion data allows the trained calibration model to predict/estimate the orientation of both or all motion-sensing devices simultaneously or substantially simultaneously (e.g., in less than a second such as 100 microseconds to 500 microseconds) using all of the available calibrated time-series motion data, which can improve accuracy and performance of the trained calibration model by maximizing the information that the trained calibration model has to make the prediction/estimate. For example, it is useful for the trained calibration model to “see” or “know” the time-series motion data from a motion-sensing device on the left side of a skier when analyzing the time-series motion data from a motion-sensing device on the left side of a skier (and vice versa).

In step 1003, the rotations from the current rotation estimate 1011 and the rotations from the model rotation estimate are combined or summed, for example according to Equation 1:

$${M}_{rot}^{n} = {S}_{rot}^{n - 1} {M}_{rel}^{n} \qquad ( 1 )$$

$${M}_{rot}^{n}$$

is a model rotation estimate 1024 for the total absolute rotation of the uncalibrated data 1012 estimated or predicted by the model for the current time period n.

$${M}_{rot}^{n}$$

can include an array/matrix of absolute rotations (e.g., defined as respective vectors), with respect to each sensor axis, about which the uncalibrated motion data 1021, for the current time period n, need to be rotated, to be in alignment with the body-segment coordinate frame 160. The absolute rotations can be represented in other ways such as quaternions or another rotation representation.

In step 1004, a new rotation estimate and an optional new error estimate is/are predicted. In one or more embodiments, the new rotation estimate is the same as the model rotation estimate 1024. In one or more other embodiments, the new rotation estimate can be determined by keeping a running average of previous model rotation estimates 1024 determined through each iteration through method 1000. The running average can be capped in time, for example using a running window of a predetermined number of the previous model rotation estimates 1024 determined through each iteration through method 1000. In one or more other embodiments, the new rotation estimate can be determined by keeping a time-weighted average of the previous model rotation estimates 1024 determined through each iteration through method 1000 where later (more recent) previous model rotation estimates 1024 are given higher weight than earlier (less recent) previous model rotation estimates 1024.

In one or more other embodiments, the new rotation estimate can be determined using a dynamic state estimator or a sequence model (in general, a dynamic state estimator). A dynamic state estimator includes an algorithmic component that maintains and updates over time a latent representation of a system's state from sequential observations and optional control inputs using explicit process/measurement models or learned mappings. The dynamic state estimator comprises one or more Kalman filters, one or more extended filters, one or more unscented filters, one or more Bayesian filters, one or more particle filters, and/or one or more recurrent neural architectures (e.g., one or more recurrent neural networks (RNNs), one or more Long Short-Term Memory networks (LSTMs), one or more Gated Recurrent Units (GRUs), and/or one or more causal transformers). In one or more embodiments, the dynamic state estimator comprises a Bayesian filter. In one or more embodiments, the Bayesian filter is or includes a Kalman filter. In one or more embodiments, the dynamic state estimator comprises an RNN.

The dynamic state estimator receives as inputs at least (a) the model rotation estimate

$${M}_{rot}^{n}$$

1024 for the current state of the motion sensors (motion-sensing device or portable computer) (e.g., for the current time period n) and (b) the current rotation estimate

$${S}_{rot}^{n - 1}$$

1011 for the last/previous state of the motion sensors (e.g., for the last time period n−1). The dynamic state estimator can also receive as an input an optional current error estimate

$${S}_{err}^{n - 1}$$

1025 for the last/previous state of the motion sensors (e.g., for the last time period n−1) and/or the optional model error estimate

$${M}_{err}^{n}$$

1023. The new rotation estimate can represent an estimated state (e.g., an estimated rotational state) of the motion sensors for the time period n relative to the body-segment coordinate frame.

Using these inputs, the dynamic state estimator determines a new/updated rotation estimate

$${S}_{rot}^{n}$$

1026 for the current state of the motion sensors (e.g., for the current time period n) and optionally a new/updated error estimate

$${S}_{err}^{n}$$

1027 for the current state of the motion sensors (e.g., for the current time period n). The new/updated error estimate

$${S}_{err}^{n}$$

1027 can represent a state uncertainty or estimate covariance. In one or more embodiments, the new/updated rotation estimate

$${S}_{rot}^{n}$$

1026 is determined as a single rotation matrix or complex rotation that has a corresponding optional current error estimate

$${S}_{err}^{n}$$

1027. In one or more other embodiments, the current rotation estimate

$${S}_{rot}^{n}$$

1026 is determined as a separate prediction for each sensor axis 151-153 with each prediction having a respective current error estimate

$${S}_{err}^{n}$$

1027. Each rotation estimate can comprise a vector describing the orientation of each axis, which can be derived from the basis vectors from a new/updated rotation matrix. It can be advantageous to separate the rotation prediction into separate axes in this manner, since during estimation, the calibration model may be more confident in the position of the yaw axis (the vertical axis) during one activity (such as when sitting on a ski lift with skis flat), but not confident in the roll or pitch axes (for example, because there is not enough significant movement to differentiate between each). So in this embodiment, the calibration model predicts three different uncertainties, one for each axis, and a single rotation matrix from which the rotation of each axis can be derived. Each update is then split into three updates for each of three separate state estimators and states.

The new/updated rotation estimate

$${S}_{rot}^{n}$$

1026 can be represented as quaternions or another rotation representation in one or more embodiments.

The new/updated rotation estimate

$${S}_{rot}^{n}$$

1026 is stored as the current rotation estimate

$${S}_{rot}^{n - 1}$$

1011 for use in the next iteration through method 1000. The optional new/updated error estimate

$${S}_{err}^{n}$$

1027 can be stored as the current rotation estimate

$${S}_{rot}^{n - 1}$$

1011 for use in the next iteration through method 1000.

In one example, the dynamic state estimator can be implemented as a Kalman filter. The inputs to the Kalman filter are or include: (a) the state rotation estimate,

$${S}_{rot}^{n - 1}$$

1011,

$${S}_{err}^{n - 1}$$

1025, also known as the state variance, (0) the model rotation estimate

$${M}_{rot}^{n}$$

1024, (d) the model error estimate

$${M}_{err}^{n}$$

1023, also known as the measurement variance, and (e) the time since last update, t. The outputs of the Kalman filter are or include: (1) the new state rotation estimate

$${S}_{rot}^{n}$$

1026 and (2) the new state error estimate

$${S}_{err}^{n}$$

1027

### The Kalman Filter can Include or Consist of the Following Algorithm:

Step 1. Modify the state error estimate to include additional uncertainty from elapsed time according to Equation 2.

$${S}_{err \_ prior}^{n} = {S}_{err}^{n - 1} + UNCERTAINTY\_RATE * t \qquad ( 2 )$$

Step 2. Calculate Kalman gain according to Equation 3.

$$k = {S}_{err \_ prior}^{n} / ( {S}_{err \_ prior}^{n} + {M}_{err}^{n} ) \qquad ( 3 )$$

Step 3. Update the state error estimate according to Equation 4.

$${S}_{err}^{n} = {S}_{err \_ prior}^{n} * ( 1 - k ) \qquad ( 4 )$$

Step 4. Update the state rotation estimate according to Equation 5.

$${S}_{rot}^{n} = slerp ( {S}_{rot}^{n - 1} , {M}_{rot}^{n} , k ) \qquad ( 5 )$$

where slerp(q₁, q₂, u) is a spherical linear interpolation that normalizes the resulting quaternion. This will interpolate between the quaternions q₁ and q₂ by parameter u. When u=0, this will return q₁. When u=1 this will return q₂. When u is between 0 and 1, this will return an interpolation between q₁ and q₂.

The system may update each axis using spherical linear interpolation with an axis-specific gain k (e.g., when stationary, trust gravity for the vertical or yaw axis, but distrust the pitch and roll estimates).

In one or more embodiments, the dynamic state estimator can adjust the new/updated rotation estimate

$${S}_{rot}^{n}$$

1026 in approximately inverse proportion to the model error estimate

$${M}_{err}^{n}$$

1023. For example, if the trained calibration model (or more generally the calibration model) is very confident in its new prediction (e.g., the model error estimate

$${M}_{err}^{n}$$

1023 is low), the dynamic state estimator will generate a new state,

$${S}_{rot}^{n} ,$$

that is very similar to this new rotation estimate from the model rotation estimate

$${M}_{rot}^{n} .$$

Conversely if the new prediction has a very high predicted error (e.g., the model error estimate

$${M}_{err}^{n}$$

1023 is high), the dynamic state estimator will mostly discard the model rotation estimate

$${M}_{rot}^{n}$$

and use the previous state estimate

$${S}_{rot}^{n - 1} .$$

In one or more embodiments, the dynamic state estimator is configured to maintain independent sub-states and covariance for each axis (e.g., yaw, pitch, and roll) and weight model updates for the new/updated rotation estimate

$${S}_{rot}^{n}$$

1026 inversely to a model-predicted axis-specific uncertainty.

In one or more embodiments, the dynamic state estimator can be configured to add or inject additional uncertainty (e.g., process noise) to the new/updated error estimate

$${S}_{err}^{n}$$

1027 to account for movement of the motion sensors (e.g., in a motion-sensing device and/or in a portable computer) between calibrations (e.g., since the last calibration and/or the last state orientation estimate). For example, the additional uncertainty can be increased as a function of time (e.g., by a predetermined number of degrees of error each hour or minute), can be increased based on a difference (e.g., variance) between the current rotation estimate (e.g., the new state estimate

$${S}_{rot}^{n}$$

1026 and/or the model rotation estimate

$${M}_{rot}^{n} )$$

and the last rotation estimate (e.g., the last/current estimate

$${S}_{rot}^{n - 1}$$

1011 and/or a model estimate

$${M}_{rot}^{n - 1} ) ,$$

and/or can be increased as a function of the elapsed time since the last calibration (e.g., to reduce the impact of a single data point if it's used in multiple overlapping calibration updates). For example, if the calibration model is configured to use the last 10 seconds of data to generate a rotation estimate and the dynamic state estimator is configured to update the state estimate every ski turn (e.g., every carved ski turn) and the ski turns occur more frequently than every 10 seconds, such as every 5 seconds, then there will be a 5 second overlap between the most recent estimate that used the last 10 seconds of time-series data and the previous estimate that occurred 5 seconds ago.

When multiple motion-sensing devices, multiple portable computers, and/or a combination of one or more motion-sensing devices and one or more portable computers are used by a skier (e.g., attached or coupled to a skier, the skier's equipment, and/or article(s) of clothing worn by the skier), method 1000 can be performed for each motion-sensing device and/or portable computer to (a) transform uncalibrated motion data 1012 from each motion-sensing device and/or portable computer to respective calibrated data based on a respective current rotation estimate 1011 and (b) determine a respective new rotation estimate 1026 for each motion-sensing device and/or portable computer. Since each motion-sensing device and/or portable computer may be oriented differently, the same rotation estimate may not be used for all motion-sensing device(s) and/or portable computer(s).

In one or more embodiments, the calibration model 1002 and/or method 1000 can utilize additional time-series motion data or and/or other data such as GPS data, microphone data, barometer data, and/or other data such as from wearables on the body (such as a mobile device or a watch) and/or from additional sensors within each motion-sensing device to provide additional context.

In one or more embodiments, method 1000 can include storing the current rotation/state estimate

$${S}_{rot}^{n - 1}$$

1011 and optionally the current error estimate

$${S}_{err}^{n - 1}$$

1025 in non-volatile memory (e.g., non-volatile memory 350, 610) such that the current rotation/state estimate

$${S}_{rot}^{n - 1}$$

1011 and current error estimate

$${S}_{err}^{n - 1}$$

1025 persist at the end of a downhill snow sport session, for example when the athlete takes a break (e.g., for lunch, rest, hot chocolate, etc.) and/or at the end of the day. After the break or lunch, the system is configured to initialize by retrieving the current rotation/state estimate

$${S}_{rot}^{n - 1}$$

1011 and current error estimate

$${S}_{err}^{n - 1}$$

1025 stored in non-volatile memory and performing method 1000 using the retrieved current state estimate

$${S}_{rot}^{n - 1}$$

1011 and current error estimate

$${S}_{err}^{n - 1}$$

1025 as a persisted updated state estimate. In one or more embodiments, the state error estimate

$${S}_{err}^{n - 1}$$

1025 is increased by a fixed amount at the start of a new sport session to reflect the increased uncertainty of the orientation of the sensor from the user possibly reorientating the device.

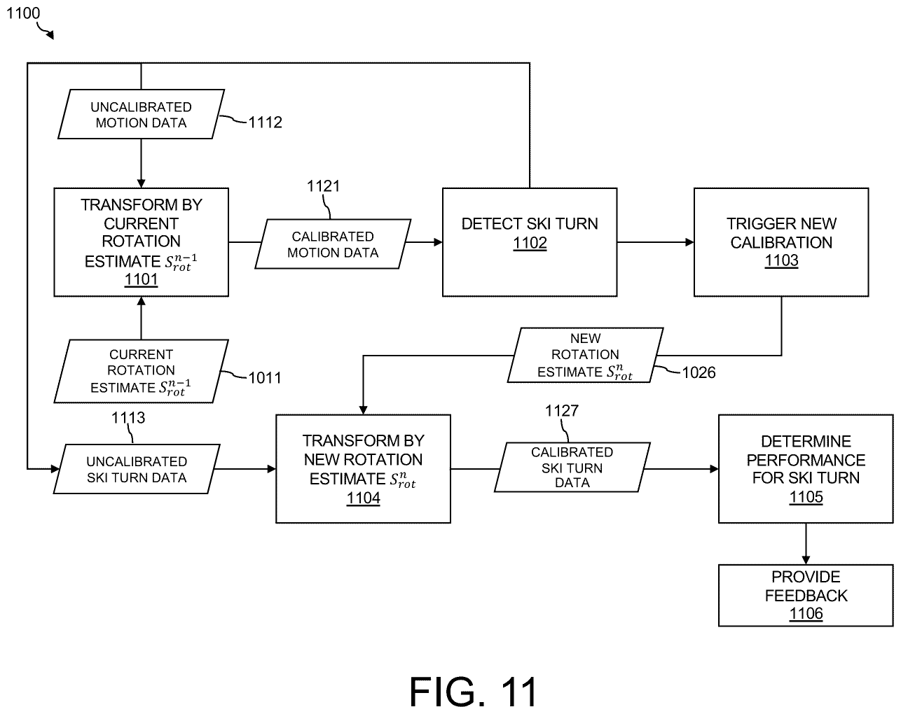

FIG. 11 is a flow chart of a computer-implemented method 1100 for analyzing skier performance and/or providing real-time performance feedback to a skier using uncalibrated motion sensors. Method 1100 can be performed after a predetermined calibration event, such as the completion of a ski turn (e.g., a carved ski turn) or the completion of a ski run (e.g., a transition of the skier onto a ski lift), and/or manual input by the skier. Predetermined thresholds can be used to prevent the method 1100 from running too often. Method 1100 can be performed by a motion-sensing device 40, 500 and/or by a portable-computer 510, 60, 70, 80.

In step 1101, uncalibrated motion data 1112 are transformed to calibrated motion data 1121 by rotating the uncalibrated motion data 1112 using a current (or most recent) rotation/state estimate

$${S}_{rot}^{n - 1}$$

1011. Step 1101 can be the same as step 1001 in one or more embodiments. The current rotation/state estimate 1011 can be determined according to method 1000. The uncalibrated motion data 1112 represents time-series motion data collected and/or output by one or more motion sensors in a common motion-sensing device (e.g., a motion-sensing device 30, 40) or in a portable computer that includes one or more motion sensors (e.g., a portable computer 80). The uncalibrated motion data 1112 can represent a current time period, such as a current time interval (e.g., the last 10 seconds, the last 20 seconds, the last 30 seconds, or another time interval) and/or the time period from the current time to a last predetermined calibration event (e.g., from the current time to the completion of a last ski turn, from the current time to the completion of a last ski run, from the current time to the completion of a break in the current ski run, or from the current time to the transition of the skier onto a ski lift). Thus, a time period can comprise a predetermined time interval or the time between the current time and the completion of a predetermined calibration event. Additionally or alternatively, the current time can represent a current/subsequent predetermined calibration event such that the time period is or includes the time from the last calibration event to the current/subsequent calibration. The uncalibrated motion data 1112 can include buffered uncalibrated motion data that includes historical and current/new motion data.

In one or more embodiments, uncalibrated motion data 1112 and the calibrated motion data 1121 are the same as uncalibrated motion data 1012 and the calibrated motion data 1021, respectively.

In step 1102, a ski turn (e.g., a carved ski turn) is detected by analyzing either the calibrated motion data 1121 or uncalibrated motion data 1112. A ski turn can be detected using the yaw, roll, and/or lateral acceleration of the skier. For example, a ski turn can be detected using peaks and troughs of the yaw angle, determining when the roll crosses zero, and/or determining when smoothed lateral acceleration crosses zero. A trained ML model, or other algorithm, can be configured to predict ski turns using this data and/or additional data.

In step 1103, a new/updated calibration of the motion-sensing device(s) and/or portable computer(s) coupled to the skier is triggered. The new/updated calibration of a motion-sensing device or a portable computer can be performed as described in method 1000. The output of the new/updated calibration is a new/updated rotation (e.g., state) estimate

$${S}_{rot}^{n}$$

1026 for the uncalibrated motion data 1112 from the sensing device or portable computer.

In step 1104, uncalibrated ski turn data 1113 are transformed by the new/updated rotation estimate

$${S}_{rot}^{n}$$

1026 to produce calibrated ski turn data 1127. The uncalibrated ski turn data 1113 can represent a subset of the uncalibrated motion data 1112 that can be selected using the ski turn detection in step 1102, for example using a time or time stamp that corresponds to the start of a ski turn and a time or time stamp that corresponds to the end of the ski turn. The new/updated rotation estimate

$${S}_{rot}^{n}$$

1020 can provide a more accurate rotation estimate for analyzing the ski turn than the current rotation estimate

$${S}_{rot}^{n - 1}$$

1011, for example to improve real-time analysis and feedback in optional steps 1005 and 1106.

The calibrated ski turn data 1127 can be processed and/or analyzed in optional step 1105 to determine the skier's performance for the ski turn and to provide optional feedback in step 1106. The skier's performance of the ski turn 1105 can be determined using a trained performance metric model 615 in one or more embodiments. In optional step 1106, feedback (e.g., sensory feedback and/or other feedback) such as visual, audible, haptic, and/or other feedback can be provided to the skier that can be based partially or wholly on the skier's performance for the current ski turn. In one or more embodiments, the optional feedback 1106 includes real-time coaching feedback relating to the ski turn.

In one or more embodiments, the calibrated ski turn data 1127 from two or more motion-sensing devices can be time-synchronized to form time-synchronized calibrated ski turn data. The time-synchronized calibrated ski turn data can be processed and/or analyzed in step 1105 to determine the skier's performance for the ski turn.

In one or more embodiments, the method 1100 can utilize additional time-series motion data or and/or other data such as GPS data, microphone data, barometer data, and/or other data such as from wearables on the body (such as a mobile device or a watch) and/or from additional sensors within each motion-sensing device.

In one or more embodiments, method 1100 can include storing the current state estimate

$${S}_{rot}^{n - 1}$$

1011 in non-volatile memory (e.g., non-volatile memory 350, 610) such that the current state estimate

$${S}_{rot}^{n - 1}$$

1011 persists at the end of a downhill snow sport session, for example when the athlete takes a break (e.g., for lunch, rest, hot chocolate, etc.) and/or at the end of the day. After the break or lunch, the system is configured to initialize by retrieving the current state estimate

$${S}_{rot}^{n - 1}$$

1011 stored in non-volatile memory and performing method 1100 using the retrieved current state estimate

$${S}_{rot}^{n - 1}$$

1011 as a persisted updated state orientation estimate.

In one or more embodiments, method 1100 can include storing the current rotation/state estimate

$${S}_{rot}^{n - 1}$$

1011 in non-volatile memory (e.g., non-volatile memory 350, 610) such that the current rotation/state estimate

$${S}_{rot}^{n - 1}$$

1011 persists at the end of a downhill snow sport session, for example when the athlete takes a break (e.g., for lunch, rest, hot chocolate, etc.) and/or at the end of the day. After the break or lunch, the system is configured to initialize by retrieving the current rotation/state estimate

$${S}_{rot}^{n - 1}$$

1011 stored In non-volatile memory and performing method 1100 using the retrieved current rotation/state estimate

$${S}_{rot}^{n - 1}$$

1011 as a persisted updated state orientation estimate.

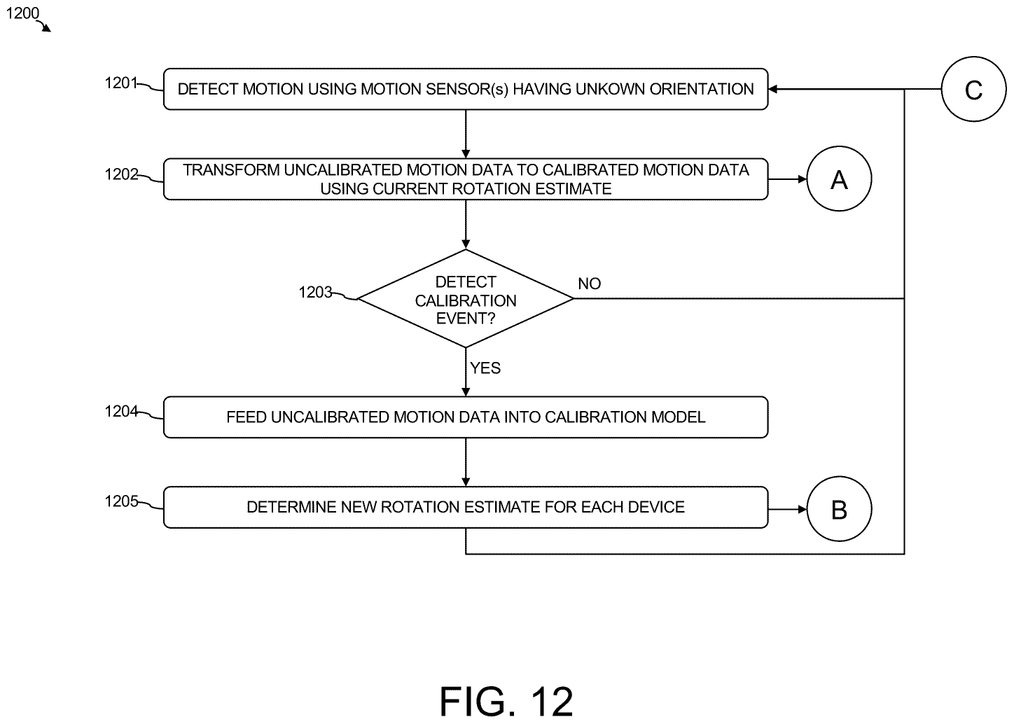

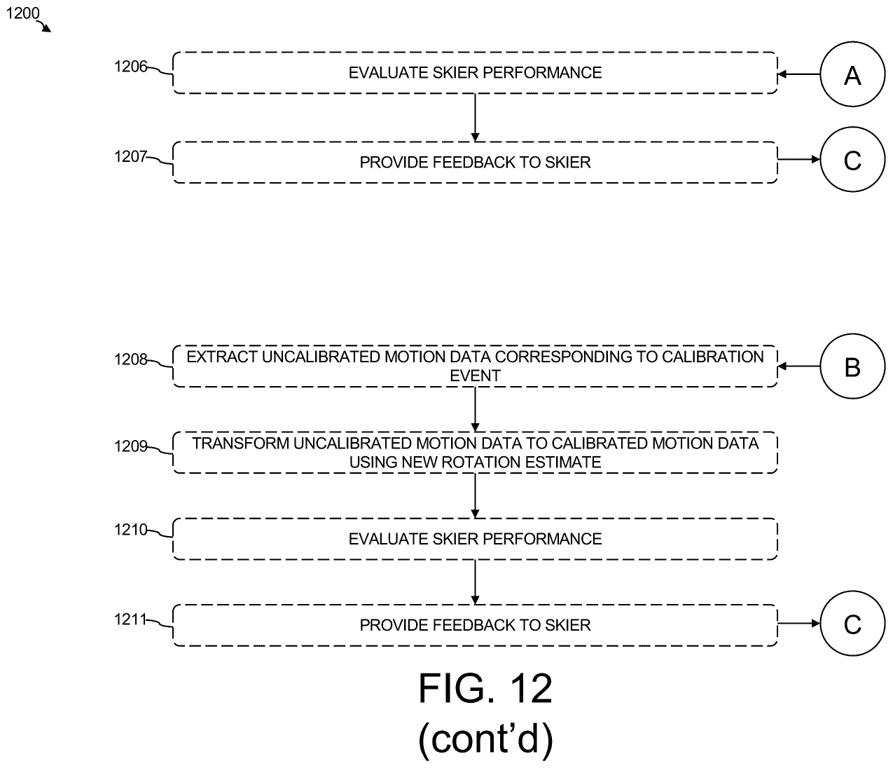

FIG. 12 is a flow chart of a method 1200 for automatically calibrating one or more motion sensors having an unknown orientation according to one or more embodiments. Method 1200 can be performed by a motion-sensing device 30, 40, 500 and/or by a portable-computer 510, 60, 70, 80.

In step 1201, a skier's motion is detected or measured using one or more motion sensors. The motion sensor(s) is/are coupled to a skier, to an article of clothing worn by the skier, and/or to a skier's equipment, such as a ski boot. The motion sensor(s) has/have an unknown orientation relative to the skier's body and to a body-segment coordinate frame 160 such that the motion sensor(s) generate uncalibrated motion data. The motion sensor(s) can include a 3D accelerometer, a 3D gyroscope, and/or a magnetometer. The motion sensor(s) can include and/or be disposed in one or more motion-sensing devices 30, 40, and/or 500 and/or in a portable computer 80. Step 1201 can be the same as step 901 in one or more embodiments.

In step 1202, the respective uncalibrated motion data from the motion sensor(s) in the same motion-sensing device or portable computer are transformed to respective calibrated motion data by rotating the respective uncalibrated motion data with respect to one or more respective sensor axes using a respective current rotation estimate for the motion sensor(s) in the same motion-sensing device or portable computer. The respective uncalibrated motion data reflect the skier's motion in a calibration coordinate frame 180 that is aligned with respect to a body-segment coordinate frame 160 according to the respective current rotation estimate. Step 1202 can be the same as step 904, step 1001, and/or step 1101 in one or more embodiments.

In step 1203, it is determined whether a calibration event is detected. A calibration event can be based on the elapsed time since the last calibration, the detection of a ski turn (e.g., the start and/or end of a ski turn such as a carved ski turn), the detection of a ski run (e.g., the start and/or end of a ski run), the transition of the skier onto a ski lift, and/or another ski event. In one or more embodiments, a calibration event is based only on the elapsed time since the last calibration, for example such that a calibration event occurs at a predetermined time interval (e.g., every 10 seconds, every 20 seconds, every 30 seconds, or another time interval). In one or more embodiments, a calibration event is based only on the detection of a ski turn (e.g., a carved ski turn), for example such that a calibration event occurs at each ski turn, every other ski turn, or another ski-turn interval. A calibration event can occur at the start of or end of a respective ski turn. A ski turn (e.g., a carved ski turn) can be detected according to step 1102 in one or more embodiments. In one or more embodiments, a calibration event is based only on the detection of a ski run, for example such that a calibration event occurs at each ski run, such as at the start of a respective ski run, the end of a respective ski run, or the transition of the skier onto a ski lift after the respective ski run. In one or more embodiments, a calibration event is based on a combination of elapsed time and the detection of a ski event. For example, a calibration event can occur at the earliest occurrence of (a) a predetermined time interval since the last calibration or (b) the detection of a ski event such as a ski turn or the beginning and/or end of a ski run. In one or more embodiments, a calibration event can be initiated manually such as through an explicit user input.

If a calibration event is not detected in step 1203 (i.e., step 1203=no), the method 1200 returns to step 1201 in a loop until a calibration event is detected in step 1203. When a calibration event is detected in step 1203 (i.e., step 1203=yes), in step 1204 the respective uncalibrated motion data from the motion sensor(s) in each motion-sensing device and/or portable computer are fed together or separately into a calibration model (e.g., a calibration model 400). Step 1204 can be the same as step 902, 1002, and/or step 1103 in one or more embodiments.

In step 1205, a new respective rotation estimate is determined for each motion-sensing device and/or portable computer. Step 1205 can be the same as step 903, 1004, and/or step 1103 in one or more embodiments. After step 1205, the method 1200 returns to step 1201 in a loop where in the next iteration through step 1202 the current rotation estimate is the new respective rotation estimate determined in step 1205.

In one or more embodiments, after step 1202 (via placeholder A), the skier's performance can be evaluated using the respective calibrated motion data in optional step 1206. In one or more embodiments, the skier's performance can be determined by feeding the respective calibrated motion data into a trained performance metric model 615. The skier's performance can be represented as one or more metrics and/or scores. Step 1206 can be the same as step 905 and/or step 1031 in one or more embodiments.

In optional step 1207, visual, audible, haptic, and/or other feedback (e.g., sensory feedback and/or other feedback) can be provided to the skier based partially or wholly on the skier's performance (e.g., determined in optional step 1206). Optional step 1207 can be the same as step 906 and/or step 1032 in one or more embodiments. After optional step 1206 or optional step 1207, the method 1200 returns to step 1201 (via placeholder C) in a loop.

In one or more embodiments, after step 1205 (via placeholder B), respective uncalibrated motion data corresponding to the detected calibration event are extracted in optional step 1208. For example, when a ski turn (e.g., a carved ski turn) is detected as a calibration event, respective uncalibrated motion corresponding to the ski turn can be extracted from a larger uncalibrated motion dataset (e.g., from a buffered uncalibrated motion dataset), for example using time stamps that indicate the beginning and end of the ski turn. In another example, when the calibration event is the completion of a ski run (or segment of a ski run) is detected as a calibration event, respective uncalibrated motion corresponding to the ski run (or segment of the ski run) can be extracted from a larger uncalibrated motion dataset, for example using time stamps that indicate the beginning and end of the ski run (or segment of the ski run). In another example, when the calibration event is a predetermined time interval (e.g., 10 seconds since the last calibration), the respective uncalibrated motion corresponding to the predetermined time interval (e.g., 10 seconds since the last calibration) are extracted from a larger uncalibrated motion dataset. In another example, when the calibration event is initiated manually (e.g., in response to explicit user input), the respective uncalibrated motion corresponding to the predetermined time interval can be extracted from a larger uncalibrated motion dataset, for example using time stamps that correspond to the last time the motion sensor(s) was/were calibrated, such as a last calibration event.

In optional step 1209, the respective uncalibrated motion data corresponding to the detected calibration event are transformed to respective calibrated motion data using the new respective rotation estimate determined in step 1205. Step 1209 can be the same as step 1104 in one or more embodiments. An advantage of transforming the respective uncalibrated motion data corresponding to the detected calibration event to respective calibrated motion data using the most recent respective rotation estimate determined in step 1205 is that the motion data is calibrated using the current (and most accurate) rotation estimate to improve accuracy and analysis of the motion data associated with the calibration event. Another advantage is that transforming historical and current/new uncalibrated motion data to respective calibrated data, using the most recent respective rotation estimate determined in step 1205, allows the respective historical and current/new calibrated motion data to share a common frame of reference.

In optional step 1210, the skier's performance corresponding to the detected calibration event can be evaluated using the respective calibrated motion data output from step 1209. Step 1210 can be the same as step 1105 in one or more embodiments.

In optional step 1211, visual, audible, haptic, and/or other feedback (e.g., sensory feedback and/or other feedback) can be provided to the skier based partially or wholly on the skier's performance (e.g., determined in optional step 1210) for the detected calibration event. Optional step 1211 can be the same as step 1106 in one or more embodiments. After optional step 1208, 1209, 1210, or step 1211, the method 1200 returns to step 1201 (via placeholder C) in a loop.

In one or more embodiments, the method 1200 can utilize additional time-series motion data or and/or other data such as GPS data, microphone data, barometer data, and/or other data such as from wearables on the body (such as a mobile device or a watch) and/or from additional sensors within each motion-sensing device.

In one or more embodiments, method 1200 can include storing the respective current rotation/state estimate for each motion-sensing device in non-volatile memory (e.g., non-volatile memory 350, 610) such that the current rotation/state estimate persists at the end of a downhill snow sport session, for example when the athlete takes a break (e.g., for lunch, rest, hot chocolate, etc.) and/or at the end of the day. After the break or lunch, the system is configured to initialize by retrieving the current rotation/state estimate stored in non-volatile memory and performing method 1200 using the retrieved current rotation/state estimate as a persisted updated state orientation estimate.

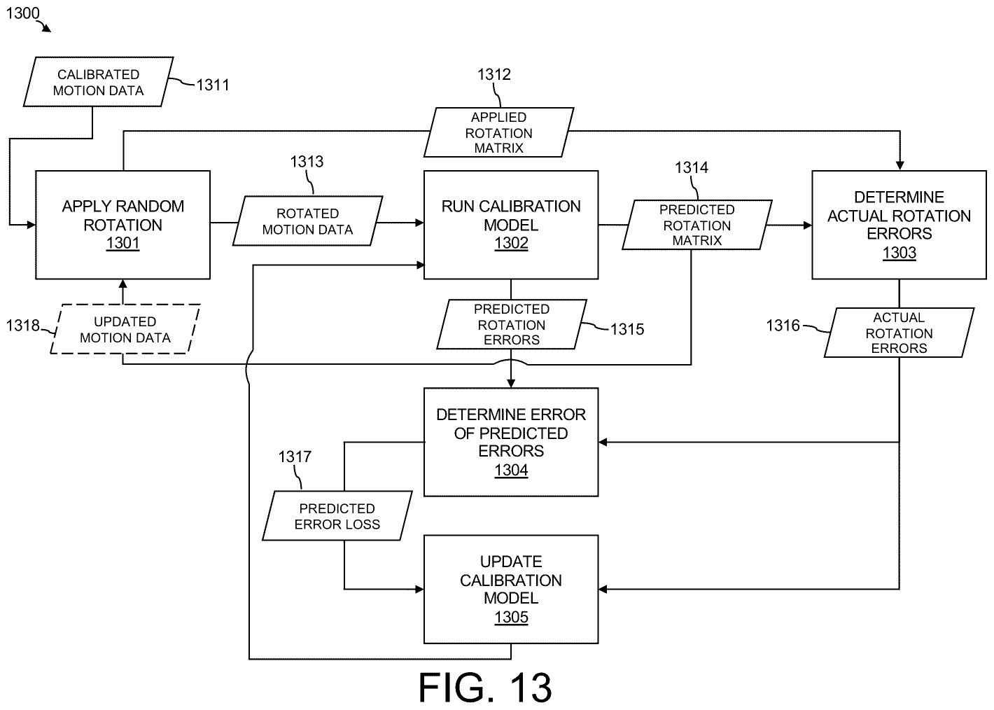

FIG. 13 is a flow chart of a computer-implemented method 1300 for training a calibration model (e.g., a calibration ML model) according to one or more embodiments. A trained calibration ML model is configured to predict/estimate the rotational orientation of motion sensor(s), relative to a body-segment coordinate frame, directly from uncalibrated time-series motion data.

In step 1301, random rotation is applied to calibrated time-series motion data 1311 to produce rotated motion data 1312. The calibrated motion data 1311 are oriented so as to be aligned with a body-segment coordinate frame 160. For example, motion data can be generated from motion sensors that are in a known or fixed orientation relative to the skier or to the skier's equipment and to the body-segment coordinate frame 160. A known/predetermined rotation can be applied to the motion data to transform the motion data to calibrated motion data 1311. In one example, the motion data can be generated from motion sensors that are disposed on/in the insole of a ski boot. In another example, the motion data can comprise or consist of inertial sensor data from motion sensors (e.g., inertial sensors) that are disposed in a portable computer such as a smartphone disposed on a skier 10. The calibrated motion data 1311 can represent a predetermined time frame (e.g., 10 seconds, 20 seconds, 30 seconds, or another time frame), a ski event (e.g., a ski turn or a ski run), and/or the time between consecutive ski events (e.g., the time from the end of a last ski turn to the end of a current ski turn), which can be referred to as a set of calibrated motion data 1311, such that the volume/time of calibrated motion data 1311 correspond the volume/time of uncalibrated data processed by a trained calibration model (e.g., after a calibration event). A ski turn or a ski run can alternately be referred to as a reference ski turn or a reference ski run, respectively. The calibrated motion data 1311 can also reflect other activities typically performed by a skier or snowboarder, such as walking, being on a ski lift, waiting in line, taking breaks on a ski slope, etc.

The random rotation can be with respect to one or more of the sensor axes 151-153 by applying a rotation matrix 1312 to the calibrated motion data 1311. The output of step 1301 is synthetic rotated time-series motion data 1313 that have a random rotational offset with respect to one or more of the sensor axes 151-153 relative to a body-segment coordinate frame 160. The random rotational offset simulates the unknown orientation of the motion sensors during use. The random rotation can be represented as quaternions or another rotational representation in one or more embodiments.

In step 1302, the rotated motion data 1313 (e.g., one or more sets of rotated motion data 1313) are fed into a calibration model (e.g., an untrained calibration ML model) alongside any additional time-series motion data or and/or other data such as GPS data, microphone data, barometer data, and/or other data such as from wearables on the body (such as a mobile device or a watch) and/or from additional sensors within each motion-sensing device, to predict the rotational offset of the rotated motion data 1313 with respect to one or more of the sensor axes 151-153 relative to a body-segment coordinate frame 160. The outputs of step 1302 are a predicted rotation matrix 1314 and predicted rotation errors (e.g., a predicted rotation error matrix) 1315 of the predicted rotation matrix 1314, one error for each sensor axis.

In step 1303, the actual rotation errors are determined with respect to each sensor axis 151-153. The actual rotation errors are determined using, as inputs, the applied rotation matrix 1312 and the predicted rotation matrix 1314. The outputs of step 1303 are the actual rotation errors (e.g., an actual rotation error matrix) 1316 that represents the difference between the predicted rotation matrix 1314 and the applied rotation matrix 1312.

In step 1304, an error of the predicted error is determined with respect to each sensor axis 151-153. The error of the predicted errors are determined using, as inputs, the actual rotation errors 1316 and the predicted rotation errors 1315. The output of step 1303 is a predicted error loss 1317.

In step 1305, the actual rotation errors 1316 and the predicted error loss 1317 are fed back to the calibration model. The calibration model is updated according to and/or using the actual rotation errors 1316 and the predicted error loss 1317.

After step 1305, the method 1300 returns to step 1302 in a loop where in the next iteration through step 1302 a second set of synthetic rotated motion data 1313 are fed into an updated calibration model (e.g., updated in step 1305) to predict the rotational offset of the second set of synthetic rotated motion data 1313 with respect to one or more of the sensor axes 151-153 relative to a body-segment coordinate frame 160. In one or more embodiments, step 1301 can be performed in parallel with or prior to step 1305 such that the next set of rotated motion data 1313 are ready to be fed into the updated calibration model in step 1302 as soon as the calibration model is updated in 1305.

In one or more embodiments, the method 1300 can be performed iteratively/continuously until the predicted rotation errors 1315 are lower than a predetermined value and/or one or statistics of the predicted rotation errors 1315 meet or exceed a respective predetermined value. Examples of statistics of the predicted rotation errors 1315 can include an average (mean), a median, a variance, and/or other statistic(s).

In one or more embodiments, the method 1300 can be performed iteratively (e.g., run N times in succession) on each set of the rotated motion data 1313 to iteratively refine the estimate. For example, the method 1300 can be run a first time using a raw set of rotated motion data 1313 and then a second pass on updated motion data 1318 rotated by the result of the first/last pass (e.g., using the predicted rotation matrix 1314), and after each pass the losses can be calculated and the model updated.

In one or more embodiments, each set of calibrated motion data 1311 and each respective set of rotated motion data 1313 are labelled with a side (e.g., left or right side) of the skier on which the respective motion sensors were located during data collection. The labelled rotated motion data 1313 can be fed into the calibration model during training in step 1302 to train the calibration model to predict the side of the skier on which the respective motion sensors were located during data collection. Thus, the trained calibration model can be configured to predict the side of the skier or snowboarder on which a motion-sensing device is located, placed, attached.

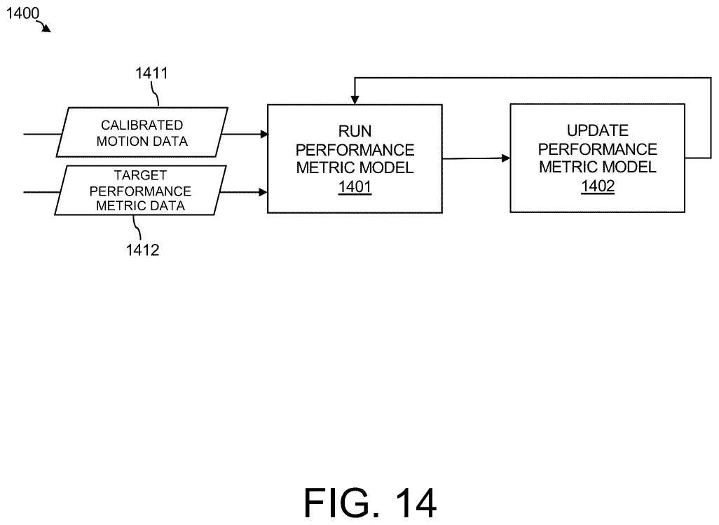

FIG. 14 is a flow chart of a computer-implemented method 1400 for training a performance metric model (e.g., a performance metric ML model) for a downhill snow sport according to one or more embodiments.

In step 1401, calibrated time-series motion data 1411 and target performance metric data 1412 are fed as inputs to an untrained performance metric model. The calibrated time-series motion data 1411 can be fed as sets of calibrated time-series motion data 1411, where each set represents a respective time period. The time period of each set of calibrated time-series motion data 1411 can be the same for all sets in one or more embodiments. Alternatively, the time period of each set of calibrated time-series motion data 1411 can be variable. In one or more embodiments, the calibrated time-series motion data 1411 can be the same as the calibrated time-series motion data 1311. The calibrated time-series motion data 1411 were previously collected from motion sensors having a known rotational orientation with respect to a body-segment coordinate frame 160 and/or were previously transformed from uncalibrated time-series data using a rotation estimate output from a calibration model, as discussed herein.

The target performance metric data 1412 represent downhill snow sport performance scores, analyses (e.g., turn detection), and/or other performance data that were previously calculated and/or analyzed for the respective calibrated time-series motion data 1411. For example, each set of calibrated time-series motion data 1411 has one or more respective/corresponding performance metrics (e.g., a respective set of target performance metric data 1412).

In step 1402, the performance metric model is updated based on and/or using the calibrated time-series motion data 1411 and target performance metric data 1412. Step 1402 can be performed after each set of calibrated time-series motion data 1411 and respective set of target performance metric data 1412 are fed to the untrained performance metric model in step 1401. Alternatively, step 1402 can be performed after a predetermined number of sets of calibrated time-series motion data 1411 and respective sets of target performance metric data 1412 are fed to the untrained performance metric model in step 1401.

Steps 1401 and 1402 can be performed iteratively in a loop. For example, steps 1401 and 1402 can be performed iteratively for all sets of calibrated time-series motion data 1411 and respective sets of target performance metric data 1412. The trained performance metric model can be tested using one or more sample sets of calibrated motion data where each sample set of calibration motion data has a respective known set of performance metric data. The performance metric data predicted/determined by the trained performance metric model can be compared with the respective known set of performance metric data to evaluate the training, for example to determine whether training is complete or whether additional training is needed.

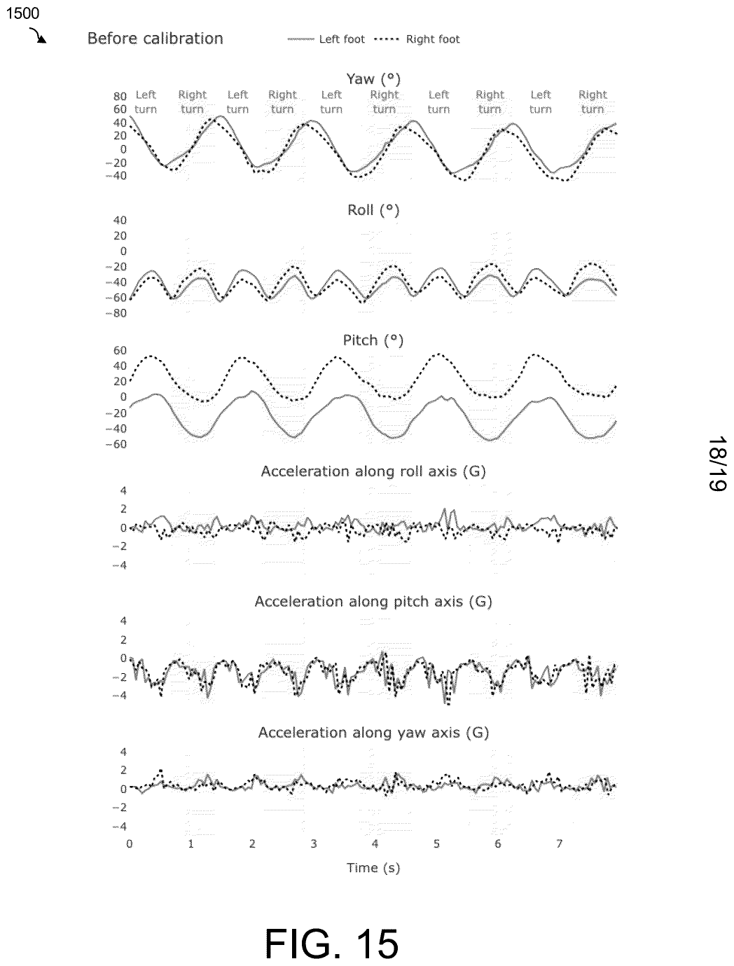

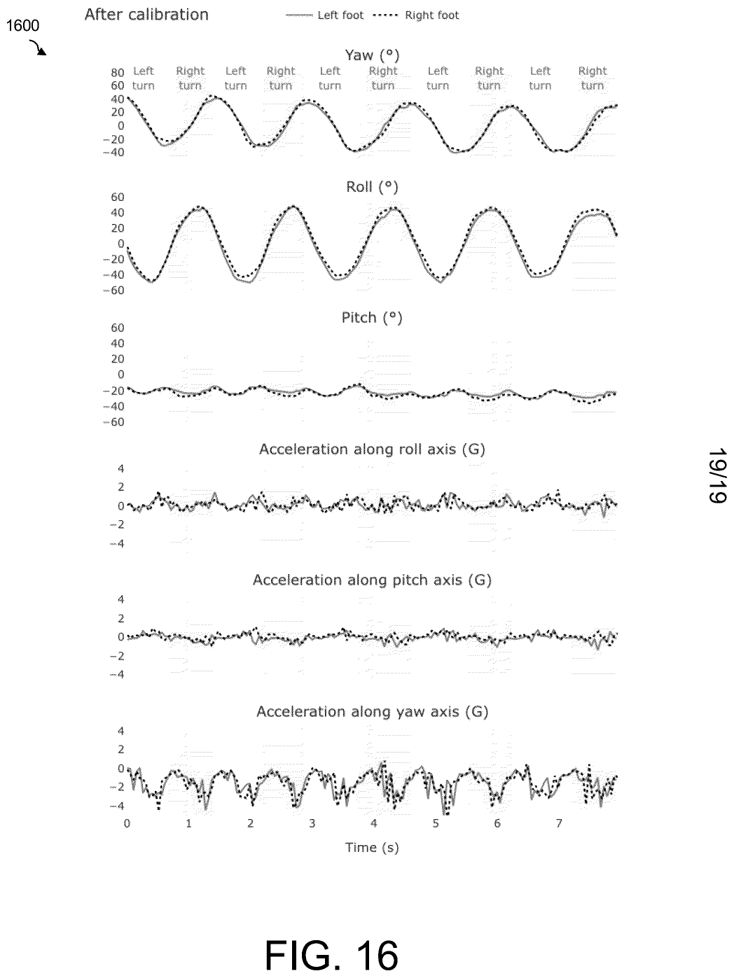

FIG. 15 and FIG. 16 show examples of uncalibrated time-series motion data 1500 and calibrated time-series motion data 1600, respectively. As can be seen, the roll and pitch angles of the uncalibrated time-series motion data 1500 are inaccurate. The roll angle data in the uncalibrated time-series motion data 1500 has about twice the frequency as the roll angle data in the calibrated time-series motion data 1600, and the pitch angle data in the uncalibrated time-series motion data 1500 has a range of 50 degrees, implying an unrealistically steep slope, not to mention the 50 degree pitch offset between skis. These data can be explained by the misalignment of the sensor device to the body-segment coordinate frame of the ski boot. For example, for the uncalibrated time-series motion data 1500, the roll angle was calculated as the angle of the roll axis above the horizon. When the roll axis (e.g., the first sensor axis 151) of a motion-sensing device or portable computer points skew forwards and downward, each time the boot and skis roll in each direction, the angle increases as the sensor roll axis gets closer to the horizon, so the peaks for each turn direction are in the same direction, causing double the frequency and resulting in inaccurate motion data and performance analysis.

### EXAMPLE IMPLEMENTATIONS

### Example 1

A computer-implemented method for providing real-time performance feedback, comprising: a. receiving, at one or more processors, uncalibrated time-series motion data generated by one or more motion sensors coupled directly or indirectly to an athlete while performing a downhill snow sport that includes curved turns, the one or more motion sensors having an unknown rotational orientation relative to the athlete; b. feeding the uncalibrated time-series motion data into a calibration model executed by the one or more processors, the calibration model configured to determine an estimated rotational offset of the one or more motion sensors relative to a body-segment coordinate frame of the athlete; c. transforming, by the one or more processors, the uncalibrated time-series motion data to calibrated time-series motion data according to the estimated rotational offset, the calibrated time-series motion data aligned with the body-segment coordinate frame; and d. processing the calibrated time-series data, with the one or more processors, to determine one or more metrics for the athlete.

### Example 2

The method of Example 1, wherein the one or more motion sensors include(s) only a three-dimensional (3D) gyroscope and/or a 3D accelerometer.

### Example 3

The method of any of Examples 1 or 2, wherein determining the estimated rotational offset includes (i) aligning a vertical axis of the body-segment coordinate frame with gravity and (ii) selecting a rotation about the vertical axis that maximizes time-smoothed lateral acceleration during a plurality of the curved turns relative to fore-aft acceleration.

### Example 4

The method of any of Examples 1-3, wherein execution of the calibration model is triggered at turn boundaries detected from zero-crossings of roll, extrema of yaw rate, and/or sign changes in lateral acceleration.

### Example 5

The method of any of Examples 1-4, wherein: the one or more motion sensors is/are disposed in a motion-sensing device, and the method further comprises sending the uncalibrated time-series motion data from the motion-sensing device to a portable computer, the portable computer including the one or more processors.

### Example 6

The method of any of Examples 1-5, wherein the one or more motion sensors is/are disposed in a portable computer, the portable computer including the one or more processors.

### Example 7

The method of Example 6, wherein the portable computer comprises a smartphone.

### Example 8

The method of any of Examples 1-7, wherein the calibration model comprises a trained machine-learning (ML) model configured to determine the rotational offset of the one or more motion sensors directly from the uncalibrated time-series motion data.

### Example 9

The method of any of Examples 1-8, wherein the trained ML model was trained with a plurality of sets of randomly rotated time-series motion data, each set of randomly rotated time-series motion data having a respective known rotational offset relative to the body-segment coordinate frame.

### Example 10

The method of any of Examples 1-9, wherein: the one or more motion sensors is/are disposed in a portable computer, the portable computer comprises a smartphone, and the uncalibrated time-series motion data used to train the trained ML model are only smartphone inertial data acquired during reference carved turns.

### Example 11

The method of any of Examples 1-10, further comprising: processing the calibrated time-series data, with the one or more processors, to evaluate a performance of the athlete; and producing real-time sensory feedback to the athlete, the real-time sensory feedback corresponding to the performance of the athlete.

### Example 12

The method of any of Examples 1-11, further comprising producing real-time sensory feedback to the athlete, the real-time sensory feedback corresponding to the one or more metrics.

### Example 13

The method of any of Example 12, wherein the real-time sensory feedback includes a coaching cue.

### Example 14

The method of any of Examples 1-13, wherein the calibration model comprises an attitude estimator or a quaternion estimator algorithm.

### Example 15

The method of any of Examples 1-14, wherein the body-segment coordinate frame includes yaw, pitch, and roll axes that are mutually orthogonal.

### Example 16

The method of Example 15, wherein the calibration model is configured to independently determine a respective estimated rotational offset with respect to each of the yaw, pitch, and roll axes.

### Example 17

The method of any of Examples 1-16, wherein: the uncalibrated time-series motion data are received from a plurality of motion-sensing devices, each motion-sensing device including a respective one or more motion sensors, and the method further comprises: time-synchronizing the uncalibrated time-series motion data from the plurality of motion-sensing devices before the uncalibrated time-series motion data; and feeding time-synchronized uncalibrated time-series motion data into the calibration model to determine a respective estimated rotational offset of each motion-sensing device relative to the body-segment coordinate frame of the athlete.

### Example 18

The method of Example 17, wherein the estimated rotational offsets for left and right devices are determined jointly using the time-synchronized uncalibrated time-series motion data to maximize inter-device symmetry of roll and yaw waveforms during a respective curved turn.

### Example 19

The method of Example 17 or 18, wherein the motion-sensing devices include a first motion-sensing device associated with a first foot or a first leg on a first side of the athlete, and a second motion-sensing device associated with a second foot or a second leg on a second side of the athlete.

### Example 20

The method of Example 19, wherein the calibration model is configured to predict the first and second sides.

### Example 21

The method of any of Examples 1-20, further comprising determining a state orientation estimate for the one or more motion sensors based, at least in part, on the estimated rotational offset.

### Example 22

The method of any of Examples 1-21, further comprising determining, by the one or more processors and with the calibration model, a confidence value representing an uncertainty associated with the estimated rotational offset.

### Example 23

The method of Example 22, wherein the state orientation estimate is updated using a dynamic state estimator that receives as inputs at least the confidence value and the estimated rotational offset.

### Example 24

The method of Example 23, wherein the dynamic state estimator maintains independent sub-states and covariance for yaw, pitch, and roll and weights model updates inversely to a model-predicted axis-specific uncertainty.

### Example 25

The method of Example 23 or 24, wherein the dynamic state estimator includes a Bayesian filter.

### Example 26

The method of Example 25, wherein the Bayesian filter comprises a Kalman filter.

### Example 27

The method of any of Examples 21-26, further comprising injecting process noise into the dynamic state estimator, the process noise corresponding to an elapsed time since a last state orientation estimate and/or a difference between a current estimated rotational offset and a last estimated rotational offset.

### Example 28

The method of any of Examples 21-27, wherein the state orientation estimate includes three independent sub-states representing yaw, pitch, and roll axes.

### Example 29

The method of any of Examples 21-28, further comprising transforming buffered uncalibrated time-series motion data for the downhill snow sport using the state orientation estimate so that historical motion data and current motion data share a common frame of reference.

### Example 30

The method of any of Examples 21-29, further comprising persisting an updated state orientation estimate in non-volatile memory operably coupled to the one or more processors, at an end of a downhill snow sport session and initializing a subsequent downhill snow sport session with a persisted updated state orientation estimate.

### Example 31

The method of any of Examples 1-30, further comprising: e. feeding the calibrated time-series motion data into the calibration model to determine an updated estimated rotational offset of the one or more motion sensors relative to the body-segment coordinate frame of the athlete; f. transforming, by the one or more processors, the calibrated time-series motion data to updated calibrated time-series motion data according to the updated estimated rotational offset; and g. repeating steps e and f iteratively wherein in a current iteration the calibrated time-series motion data fed into the calibration model in step b is the updated calibrated time-series motion data transformed in step f in a last iteration.

### Example 32

The method of any of Examples 1-31, further comprising triggering an execution of step b in response to a calibration event.

### Example 33

The method of Example 32, wherein the calibration event includes a completion of a curved ski turn, a completion of a ski run, a transition onto a ski lift, and/or an explicit user input.

### Example 34

A portable computer comprising: one or more processors; a plurality of motion sensors in communication with the one or more processors; non-volatile computer memory operably coupled to the one or more processors, the non-volatile computer memory storing computer-readable instructions that, when executed by the one or more processors, cause the one or more processors to: a. receive at least a set of uncalibrated time-series motion data generated by the one or more motion sensors while an athlete performs a downhill snow sport that includes curved turns, the one or more motion sensors having an unknown rotational orientation relative to the athlete; b. transform the set of uncalibrated time-series motion data to a set of calibrated time-series motion data by rotating the set of uncalibrated time-series motion data according to a current rotation estimate for the one or more motion sensors, the current rotation estimate determined relative to a body-segment coordinate frame of the athlete; c. determine, with a calibration model running on the one or more processors, a predicted rotation estimate for the set of calibrated time-series motion data relative to the body-segment coordinate frame of the athlete; d. combine the predicted rotation estimate and the current rotation estimate to form a model rotation estimate; e. determine an updated rotation estimate, relative to the body-segment coordinate frame of the skier, for the one or more motion sensors based at least in part on the model rotation estimate; and f. replace the current rotation estimate with the updated rotation estimate.

### Example 35

The portable computer of Example 34, wherein the computer-readable instructions, when executed by the one or more processors, further cause the one or more processors to determine, with the calibration model, a model error estimate of the model rotation estimate.

### Example 36

The portable computer of Example 35, wherein in step e the updated rotation estimate for the one or more motion sensors is determined using as inputs the model error estimate, the model rotation estimate, and a current state error estimate for the current rotation estimate.

### Example 37

The portable computer of Example 36, wherein the computer-readable instructions, when executed by the one or more processors, further cause the one or more processors to determine the updated rotation estimate and the current state error estimate using a dynamic state estimator running on the one or more processors.

### Example 38

The portable computer of Example 37, wherein the dynamic state estimator comprises a Kalman filter, a Bayesian filter, or a recurrent neural network.

### Example 39

The portable computer of any of Examples 36-38, wherein the computer-readable instructions, when executed by the one or more processors, further cause the one or more processors to: g. determine, using the dynamic state estimator, an updated state error estimate using as inputs at least the model error estimate and the current state error estimate for the current rotation estimate; and h. replace the current state error estimate with the updated state error estimate.

### Example 40

The portable computer of any of Examples 36-39, wherein the computer-readable instructions, when executed by the one or more processors, further cause the one or more processors to inject additional uncertainty into the dynamic state estimator, the additional uncertainty corresponding to an elapsed time since a last state orientation estimate and/or a difference between the current rotation estimate and a last rotation estimate.

### Example 41

The portable computer of any of Examples 36-40, wherein the computer-readable instructions, when executed by the one or more processors, further cause the one or more processors to process a plurality of sets of the uncalibrated time-series motion data in a plurality of loops through steps a-h so as to iteratively update (a) the current rotation estimate of the one or more motion sensors and (b) the current state error estimate of the current rotation estimate.

### Example 42

The portable computer of Example 41, wherein each set of the uncalibrated time-series motion data represents a predetermined time period or a time between a last calibration event and current calibration event.

### Example 43

The portable computer of any of Examples 34-42, wherein the computer-readable instructions, when executed by the one or more processors, further cause the one or more processors to: analyze the set of calibrated time-series data to detect a curved turn performed by the athlete; transform at least a portion of the set of uncalibrated time-series motion data corresponding to the detected curved turn to respective calibrated time-series motion data using the updated rotation estimate determined in step e; and process the respective calibrated time-series motion data to analyze a performance of the athlete during the detected curved turn.

### Example 44

The portable computer of Example 43, wherein transforming the at least a portion of the set of uncalibrated data corresponding to the detected curved turn uses the updated rotation estimate determined after the detected curved turn, thereby aligning historical and current data to a common frame.

### Example 45

The portable computer of Example 43 or 44, wherein the computer-readable instructions, when executed by the one or more processors, further cause the one or more processors to produce a sensory feedback signal that generates sensory feedback to the athlete, the sensory feedback corresponding to the performance of the athlete during the turn.

### Example 46

The portable computer of any of Examples 34-45, wherein the portable computer comprises a smartphone.

### Example 47

The portable computer of any of Examples 34-47, wherein the calibration model comprises a trained machine-learning (ML) model.

### Example 48

The portable computer of Example 47, wherein the trained ML model was trained with a plurality of sets of randomly rotated time-series motion data, each set of randomly rotated time-series motion data having a respective known rotational offset relative to the body-segment coordinate frame of the athlete.

### Example 49

A system comprising: one or more motion-sensing devices, each motion-sensing device configured to be coupled at an unknown orientation to a skier, a ski boot, a ski binding, and/or a ski, each motion-sensing device including: one or more motion sensors configured to generate uncalibrated time-series motion data corresponding to a movement of the skier; first communications circuitry; one or more first processors coupled to the one or more motion sensors and the first communications circuitry; and a portable computer in communication with the one or more motion-sensing devices, the portable computer comprising: second communications circuitry; one or more second processors coupled to the second communications circuitry; and non-volatile computer memory coupled to the one or more second processors, the second non-volatile computer memory storing computer-readable instructions that, when executed by the one or more second processors, cause the one or more second processors to: a. receive one or more sets of uncalibrated time-series motion data, each set of uncalibrated time-series motion data sent from a respective motion-sensing device; b. transform the one or more sets of uncalibrated time-series motion data to one or more sets of calibrated time-series motion data, respectively, by rotating each set of uncalibrated time-series motion data according to a respective current rotation estimate for each motion-sensing device relative to a body-segment coordinate frame of the skier; c. determine, with a calibration model running on the one or more second processors, for each motion-sensing device: a respective model rotation estimate for each set of calibrated time-series motion data relative to the body-segment coordinate frame of the skier; d. combine the respective relative model rotation estimate and the respective current rotation estimate to form a respective model rotation estimate for each motion-sensing device; e. determine a respective updated rotation estimate, relative to the body-segment coordinate frame of the skier, for each motion-sensing device based at least in part on the respective model rotation estimate; and f. replace the respective current rotation estimate for each motion-sensing device with the respective updated rotation estimate.

### Example 50

The system of Example 49, wherein: the one or more motion-sensing devices comprises a plurality of the motion-sensing devices, and time-synchronization between the motion-sensing devices is/was established by estimating and removing round-trip latency through repeated timestamp exchanges and/or by detecting a common impulsive event captured by onboard microphones or accelerometers.

### Example 51

The system of Example 49 or 50, wherein the one or more motion-sensing devices comprises at least a first motion-sensing device configured to be coupled to a first pant leg, a first ski boot, a first ski binding, or a first ski, and a second motion-sensing device configured to be coupled to a second pant leg, a second ski boot, a second ski binding, or a second ski.

### Example 52

The system of any of Examples 49-51, wherein the computer-readable instructions, when executed by the one or more second processors, further cause the one or more second processors to determine, with the calibration model, a respective model error estimate of the respective model rotation estimate.

### Example 53

The system of Example 52, wherein in step e the respective updated rotation estimate for each motion-sensing device is determined using as inputs the respective model error estimate, the respective model rotation estimate, and a respective current state error estimate for the respective current rotation estimate.

### Example 54

The system of Example 53, wherein the computer-readable instructions, when executed by the one or more second processors, further cause the one or more second processors to determine the respective updated rotation estimate and the respective current state error estimate using a dynamic state estimator running on the one or more second processors.

### Example 55

The system of Example 54, wherein the dynamic state estimator comprises a Kalman filter, a Bayesian filter, or a recurrent neural network.

### Example 56

The system of Example 53 or 54, wherein the computer-readable instructions, when executed by the one or more second processors, further cause the one or more second processors to: g. determine, using the dynamic state estimator, a respective updated state error estimate using as inputs at least the respective model error estimate and the respective current state error estimate for the respective current rotation estimate; and h. replace the respective current state error estimate with the respective updated state error estimate.

### Example 57

The system of Example 56, wherein the computer-readable instructions, when executed by the one or more second processors, further cause the one or more second processors to inject additional uncertainty into the respective updated state error estimate.

### Example 58

The system of Example 56 or 57, wherein the computer-readable instructions, when executed by the one or more second processors, further cause the one or more second processors to process a respective plurality of the sets of uncalibrated time-series motion data from each motion-sensing device in a plurality of loops through steps a-h so as to iteratively update (a) the respective current rotation estimate for each motion-sensing device and (b) the respective updated error estimate of each motion-sensing device.

### Example 59

The system of any of Examples 49-58, wherein the calibration model comprises a trained machine-learning (ML) model.

### Example 60

The system of Example 59, wherein the trained ML model was trained using a plurality of sets of randomly rotated time-series motion data, each set of randomly rotated time-series motion data having a respective known rotational offset relative to the body-segment coordinate frame of the skier.

### Example 61

The system of any of Examples 49-60, wherein the computer-readable instructions, when executed by the one or more second processors, further cause the one or more second processors to: analyze the one or more sets of calibrated time-series motion data to detect a ski turn performed by the skier; transform at least a portion of the one or more sets of uncalibrated time-series motion data corresponding to the ski turn to respective calibrated data time-series motion data using the respective updated rotation estimate determined in step e; and process the respective calibrated data time-series motion data to analyze a performance of the skier during the ski turn.

### Example 62

The system of Example 61, wherein the computer-readable instructions, when executed by the one or more second processors, further cause the one or more second processors to produce a sensory feedback signal that generates sensory feedback to the skier, the sensory feedback corresponding to the performance of the skier during the ski turn.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A computer-implemented method for providing real-time performance feedback, comprising:
a. receiving, at one or more processors, uncalibrated time-series motion data generated by one or more motion sensors coupled directly or indirectly to an athlete while performing a downhill snow sport that includes curved turns, the one or more motion sensors having an unknown rotational orientation relative to the athlete;
b. feeding the uncalibrated time-series motion data into a calibration model executed by the one or more processors, the calibration model configured to determine an estimated rotational offset of the one or more motion sensors relative to a body-segment coordinate frame of the athlete;
c. transforming, by the one or more processors, the uncalibrated time-series motion data to calibrated time-series motion data according to the estimated rotational offset, the calibrated time-series motion data aligned with the body-segment coordinate frame; and
d. processing the calibrated time-series data, with the one or more processors, to determine one or more metrics for the athlete.

2. The method of claim 1, wherein the one or more motion sensors include(s) only a three-dimensional (3D) gyroscope and/or a 3D accelerometer.

3. The method of claim 1, wherein determining the estimated rotational offset includes (i) aligning a vertical axis of the body-segment coordinate frame with gravity and (ii) selecting a rotation about the vertical axis that maximizes time-smoothed lateral acceleration during a plurality of the curved turns relative to fore-aft acceleration.

4. The method of claim 1, wherein execution of the calibration model is triggered at turn boundaries detected from zero-crossings of roll, extrema of yaw rate, and/or sign changes in lateral acceleration.

5. The method of claim 1, wherein:
the one or more motion sensors is/are disposed in a motion-sensing device, and
the method further comprises sending the uncalibrated time-series motion data from the motion-sensing device to a portable computer, the portable computer including the one or more processors.

6. The method of claim 1, wherein the one or more motion sensors is/are disposed in a portable computer, the portable computer including the one or more processors.

7. The method of claim 6, wherein the portable computer comprises a smartphone.

8. The method of claim 1, wherein the calibration model comprises a trained machine-learning (ML) model configured to determine the rotational offset of the one or more motion sensors directly from the uncalibrated time-series motion data.

9. The method of claim 8, wherein the trained ML model was trained with a plurality of sets of randomly rotated time-series motion data, each set of randomly rotated time-series motion data having a respective known rotational offset relative to the body-segment coordinate frame.

10. The method of claim 8, wherein:
the one or more motion sensors is/are disposed in a portable computer,
the portable computer comprises a smartphone, and
the uncalibrated time-series motion data used to train the trained ML model are only smartphone inertial data acquired during reference carved turns.

11. The method of claim 1, further comprising:
processing the calibrated time-series data, with the one or more processors, to evaluate a performance of the athlete; and
producing real-time sensory feedback to the athlete, the real-time sensory feedback corresponding to the performance of the athlete.

12. The method of claim 1, further comprising producing real-time sensory feedback to the athlete, the real-time sensory feedback corresponding to the one or more metrics.

13. The method of claim 12, wherein the real-time sensory feedback includes a coaching cue.

14. The method of claim 1, wherein the calibration model comprises an attitude estimator or a quaternion estimator algorithm.

15. The method of claim 1, wherein the body-segment coordinate frame includes yaw, pitch, and roll axes that are mutually orthogonal.

16. The method of claim 15, wherein the calibration model is configured to independently determine a respective estimated rotational offset with respect to each of the yaw, pitch, and roll axes.

17. The method of claim 1, wherein:
the uncalibrated time-series motion data are received from a plurality of motion-sensing devices, each motion-sensing device including a respective one or more motion sensors, and
the method further comprises:
time-synchronizing the uncalibrated time-series motion data from the plurality of motion-sensing devices before the uncalibrated time-series motion data; and
feeding time-synchronized uncalibrated time-series motion data into the calibration model to determine a respective estimated rotational offset of each motion-sensing device relative to the body-segment coordinate frame of the athlete.

18. The method of claim 17, wherein the estimated rotational offsets for left and right devices are determined jointly using the time-synchronized uncalibrated time-series motion data to maximize inter-device symmetry of roll and yaw waveforms during a respective curved turn.

19. The method of claim 17, wherein the motion-sensing devices include a first motion-sensing device associated with a first foot or a first leg on a first side of the athlete, and a second motion-sensing device associated with a second foot or a second leg on a second side of the athlete.

20. The method of claim 19, wherein the calibration model is configured to predict the first and second sides.

21. The method of claim 1, further comprising determining a state orientation estimate for the one or more motion sensors based, at least in part, on the estimated rotational offset.

22. The method of claim 21, further comprising determining, by the one or more processors and with the calibration model, a confidence value representing an uncertainty associated with the estimated rotational offset.

23. The method of claim 22, wherein the state orientation estimate is updated using a dynamic state estimator that receives as inputs at least the confidence value and the estimated rotational offset.

24. The method of claim 23, wherein the dynamic state estimator maintains independent sub-states and covariance for yaw, pitch, and roll and weights model updates inversely to a model-predicted axis-specific uncertainty.

25. The method of claim 23, wherein the dynamic state estimator includes a Bayesian filter.

26. The method of claim 25, wherein the Bayesian filter comprises a Kalman filter.

27. The method of claim 23, further comprising injecting process noise into the dynamic state estimator, the process noise corresponding to an elapsed time since a last state orientation estimate and/or a difference between a current estimated rotational offset and a last estimated rotational offset.

28. The method of claim 22, wherein the state orientation estimate includes three independent sub-states representing yaw, pitch, and roll axes.

29. The method of claim 22, further comprising transforming buffered uncalibrated time-series motion data for the downhill snow sport using the state orientation estimate so that historical motion data and current motion data share a common frame of reference.

30. The method of claim 22, further comprising persisting an updated state orientation estimate in non-volatile memory operably coupled to the one or more processors, at an end of a downhill snow sport session and initializing a subsequent downhill snow sport session with a persisted updated state orientation estimate.

31. The method of claim 1, further comprising:
e. feeding the calibrated time-series motion data into the calibration model to determine an updated estimated rotational offset of the one or more motion sensors relative to the body-segment coordinate frame of the athlete;
f. transforming, by the one or more processors, the calibrated time-series motion data to updated calibrated time-series motion data according to the updated estimated rotational offset; and
g. repeating steps e and f iteratively wherein in a current iteration the calibrated time-series motion data fed into the calibration model in step b is the updated calibrated time-series motion data transformed in step f in a last iteration.

32. The method of claim 1, further comprising triggering an execution of step b in response to a calibration event.

33. The method of claim 32, wherein the calibration event includes a completion of a curved ski turn, a completion of a ski run, a transition onto a ski lift, and/or an explicit user input.

34. A portable computer comprising:
one or more processors;
a plurality of motion sensors in communication with the one or more processors;
non-volatile computer memory operably coupled to the one or more processors, the non-volatile computer memory storing computer-readable instructions that, when executed by the one or more processors, cause the one or more processors to:
a. receive at least a set of uncalibrated time-series motion data generated by the one or more motion sensors while an athlete performs a downhill snow sport that includes curved turns, the one or more motion sensors having an unknown rotational orientation relative to the athlete;
b. transform the set of uncalibrated time-series motion data to a set of calibrated time-series motion data by rotating the set of uncalibrated time-series motion data according to a current rotation estimate for the one or more motion sensors, the current rotation estimate determined relative to a body-segment coordinate frame of the athlete;
c. determine, with a calibration model running on the one or more processors, a predicted rotation estimate for the set of calibrated time-series motion data relative to the body-segment coordinate frame of the athlete;
d. combine the predicted rotation estimate and the current rotation estimate to form a model rotation estimate;
e. determine an updated rotation estimate, relative to the body-segment coordinate frame of the skier, for the one or more motion sensors based at least in part on the model rotation estimate; and
f. replace the current rotation estimate with the updated rotation estimate.

35. The portable computer of claim 34, wherein the computer-readable instructions, when executed by the one or more processors, further cause the one or more processors to determine, with the calibration model, a model error estimate of the model rotation estimate.

36. The portable computer of claim 35, wherein in step e the updated rotation estimate for the one or more motion sensors is determined using as inputs the model error estimate, the model rotation estimate, and a current state error estimate for the current rotation estimate.

37. The portable computer of claim 36, wherein the computer-readable instructions, when executed by the one or more processors, further cause the one or more processors to determine the updated rotation estimate and the current state error estimate using a dynamic state estimator running on the one or more processors.

38. The portable computer of claim 37, wherein the dynamic state estimator comprises a Kalman filter, a Bayesian filter, or a recurrent neural network.

39. The portable computer of claim 36, wherein the computer-readable instructions, when executed by the one or more processors, further cause the one or more processors to:
g. determine, using the dynamic state estimator, an updated state error estimate using as inputs at least the model error estimate and the current state error estimate for the current rotation estimate; and
h. replace the current state error estimate with the updated state error estimate.

40. The portable computer of claim 39, wherein the computer-readable instructions, when executed by the one or more processors, further cause the one or more processors to inject additional uncertainty into the dynamic state estimator, the additional uncertainty corresponding to an elapsed time since a last state orientation estimate and/or a difference between the current rotation estimate and a last rotation estimate.

41. The portable computer of claim 39, wherein the computer-readable instructions, when executed by the one or more processors, further cause the one or more processors to process a plurality of sets of the uncalibrated time-series motion data in a plurality of loops through steps a-h so as to iteratively update (a) the current rotation estimate of the one or more motion sensors and (b) the current state error estimate of the current rotation estimate.

42. The portable computer of claim 41, wherein each set of the uncalibrated time-series motion data represents a predetermined time period or a time between a last calibration event and current calibration event.

43. The portable computer of claim 34, wherein the computer-readable instructions, when executed by the one or more processors, further cause the one or more processors to:
analyze the set of calibrated time-series data to detect a curved turn performed by the athlete;
transform at least a portion of the set of uncalibrated time-series motion data corresponding to the detected curved turn to respective calibrated time-series motion data using the updated rotation estimate determined in step e; and
process the respective calibrated time-series motion data to analyze a performance of the athlete during the detected curved turn.

44. The portable computer of claim 43, wherein transforming the at least a portion of the set of uncalibrated data corresponding to the detected curved turn uses the updated rotation estimate determined after the detected curved turn, thereby aligning historical and current data to a common frame.

45. The portable computer of claim 43, wherein the computer-readable instructions, when executed by the one or more processors, further cause the one or more processors to produce a sensory feedback signal that generates sensory feedback to the athlete, the sensory feedback corresponding to the performance of the athlete during the turn.

46. The portable computer of claim 34, wherein the portable computer comprises a smartphone.

47. The portable computer of claim 34, wherein the calibration model comprises a trained machine-learning (ML) model.

48. The portable computer of claim 47, wherein the trained ML model was trained with a plurality of sets of randomly rotated time-series motion data, each set of randomly rotated time-series motion data having a respective known rotational offset relative to the body-segment coordinate frame of the athlete.

49. A system comprising:
one or more motion-sensing devices, each motion-sensing device configured to be coupled at an unknown orientation to a skier, a ski boot, a ski binding, and/or a ski, each motion-sensing device including:
one or more motion sensors configured to generate uncalibrated time-series motion data corresponding to a movement of the skier;
first communications circuitry;
one or more first processors coupled to the one or more motion sensors and the first communications circuitry; and
a portable computer in communication with the one or more motion-sensing devices, the portable computer comprising:
second communications circuitry;
one or more second processors coupled to the second communications circuitry; and
non-volatile computer memory coupled to the one or more second processors, the second non-volatile computer memory storing computer-readable instructions that, when executed by the one or more second processors, cause the one or more second processors to:
a. receive one or more sets of uncalibrated time-series motion data, each set of uncalibrated time-series motion data sent from a respective motion-sensing device;
b. transform the one or more sets of uncalibrated time-series motion data to one or more sets of calibrated time-series motion data, respectively, by rotating each set of uncalibrated time-series motion data according to a respective current rotation estimate for each motion-sensing device relative to a body-segment coordinate frame of the skier;
c. determine, with a calibration model running on the one or more second processors, for each motion-sensing device: a respective model rotation estimate for each set of calibrated time-series motion data relative to the body-segment coordinate frame of the skier;
d. combine the respective relative model rotation estimate and the respective current rotation estimate to form a respective model rotation estimate for each motion-sensing device;
e. determine a respective updated rotation estimate, relative to the body-segment coordinate frame of the skier, for each motion-sensing device based at least in part on the respective model rotation estimate; and
f. replace the respective current rotation estimate for each motion-sensing device with the respective updated rotation estimate.

50. The system of claim 49, wherein:
the one or more motion-sensing devices comprises a plurality of the motion-sensing devices, and
time-synchronization between the motion-sensing devices is/was established by estimating and removing round-trip latency through repeated timestamp exchanges and/or by detecting a common impulsive event captured by onboard microphones or accelerometers.

51. The system of claim 49, wherein the one or more motion-sensing devices comprises at least a first motion-sensing device configured to be coupled to a first pant leg, a first ski boot, a first ski binding, or a first ski, and a second motion-sensing device configured to be coupled to a second pant leg, a second ski boot, a second ski binding, or a second ski.

52. The system of claim 49, wherein the computer-readable instructions, when executed by the one or more second processors, further cause the one or more second processors to determine, with the calibration model, a respective model error estimate of the respective model rotation estimate.

53. The system of claim 52, wherein in step e the respective updated rotation estimate for each motion-sensing device is determined using as inputs the respective model error estimate, the respective model rotation estimate, and a respective current state error estimate for the respective current rotation estimate.

54. The system of claim 53, wherein the computer-readable instructions, when executed by the one or more second processors, further cause the one or more second processors to determine the respective updated rotation estimate and the respective current state error estimate using a dynamic state estimator running on the one or more second processors.

55. The system of claim 54, wherein the dynamic state estimator comprises a Kalman filter, a Bayesian filter, or a recurrent neural network.

56. The system computer of claim 54, wherein the computer-readable instructions, when executed by the one or more second processors, further cause the one or more second processors to:
g. determine, using the dynamic state estimator, a respective updated state error estimate using as inputs at least the respective model error estimate and the respective current state error estimate for the respective current rotation estimate; and
h. replace the respective current state error estimate with the respective updated state error estimate.

57. The system of claim 56, wherein the computer-readable instructions, when executed by the one or more second processors, further cause the one or more second processors to inject additional uncertainty into the respective updated state error estimate.

58. The system of claim 56, wherein the computer-readable instructions, when executed by the one or more second processors, further cause the one or more second processors to process a respective plurality of the sets of uncalibrated time-series motion data from each motion-sensing device in a plurality of loops through steps a-h so as to iteratively update (a) the respective current rotation estimate for each motion-sensing device and (b) the respective updated error estimate of each motion-sensing device.

59. The system of claim 49, wherein the calibration model comprises a trained machine-learning (ML) model.

60. The system of claim 59, wherein the trained ML model was trained using a plurality of sets of randomly rotated time-series motion data, each set of randomly rotated time-series motion data having a respective known rotational offset relative to the body-segment coordinate frame of the skier.

61. The system of claim 49, wherein the computer-readable instructions, when executed by the one or more second processors, further cause the one or more second processors to:
analyze the one or more sets of calibrated time-series motion data to detect a ski turn performed by the skier;
transform at least a portion of the one or more sets of uncalibrated time-series motion data corresponding to the ski turn to respective calibrated data time-series motion data using the respective updated rotation estimate determined in step e; and
process the respective calibrated data time-series motion data to analyze a performance of the skier during the ski turn.

62. The system of claim 61, wherein the computer-readable instructions, when executed by the one or more second processors, further cause the one or more second processors to produce a sensory feedback signal that generates sensory feedback to the skier, the sensory feedback corresponding to the performance of the skier during the ski turn.
